(19) United States
(12) Patent Application Publication
(10) Pub. No.: US 2026/0252572 A1
(43) Pub. Date: Aug. 27, 2026

(54) SYSTEM

(71) Applicant: SoftBank Group Corp., Tokyo (JP)

(72) Inventor: Toshiaki NAKANISHI, Tokyo (JP)

(73) Assignee: SoftBank Group Corp., Tokyo (JP)

(21) Appl. No.: 19/539,257

(22) Filed: Feb. 13, 2026

(30) Foreign Application Priority Data
Feb. 21, 2025 (JP) 2025-026971

(51) Int. Cl. G06F 16/2457; G06F 3/0482; G06F 16/9535; G06Q 10/06; G06Q 10/10

(52) U.S. Cl. CPC G06F 16/24578; G06F 3/0482; G06F 16/9535; G06Q 10/06; G06Q 10/10

(57) ABSTRACT

The system according to the embodiment comprises a reception unit, a generation unit, an input unit, and a creation unit. The reception unit inputs a kitting item name. The generation unit generates a response based on the item name input by the reception unit. The input unit inputs the response generated by the generation unit into a master template. The creation unit automatically creates a kitting procedure manual based on the master input by the input unit.

### CROSS-REFERENCE TO RELATED APPLICATION

The present application claims priority to and incorporates by reference the entire contents of Japanese Patent Application No. 2025-026971 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, the creation of kitting procedure manuals has been performed manually, resulting in poor efficiency and requiring a significant amount of time.

### SUMMARY OF THE INVENTION

The system according to the embodiment comprises a reception unit, a generation unit, an input unit, and a creation unit. The reception unit inputs a kitting item name. The generation unit generates a response based on the item name input by the reception unit. The input unit inputs the response generated by the generation unit into a master template. The creation unit automatically creates a kitting procedure manual based on the master input by the input unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

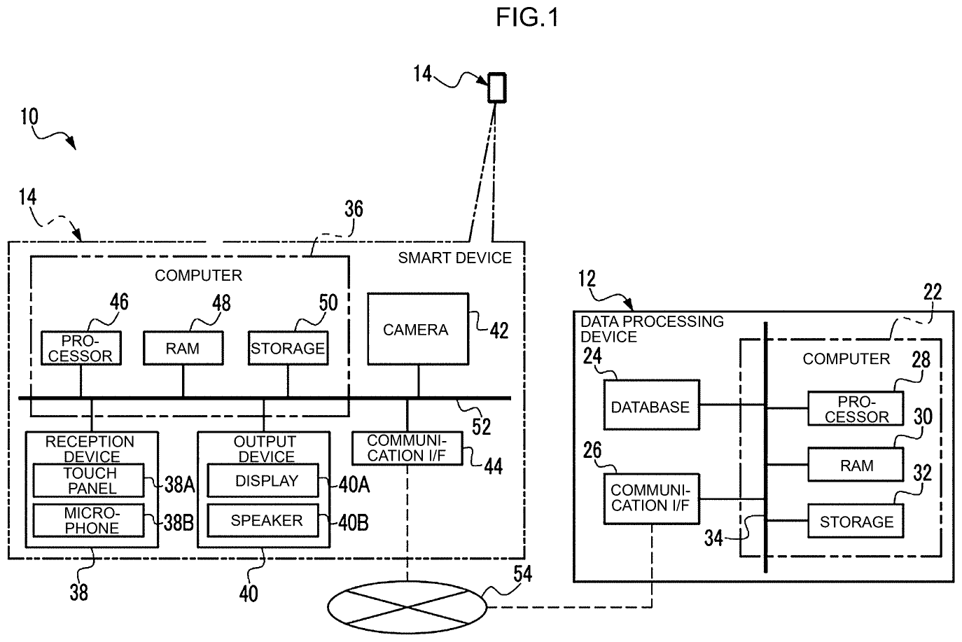

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

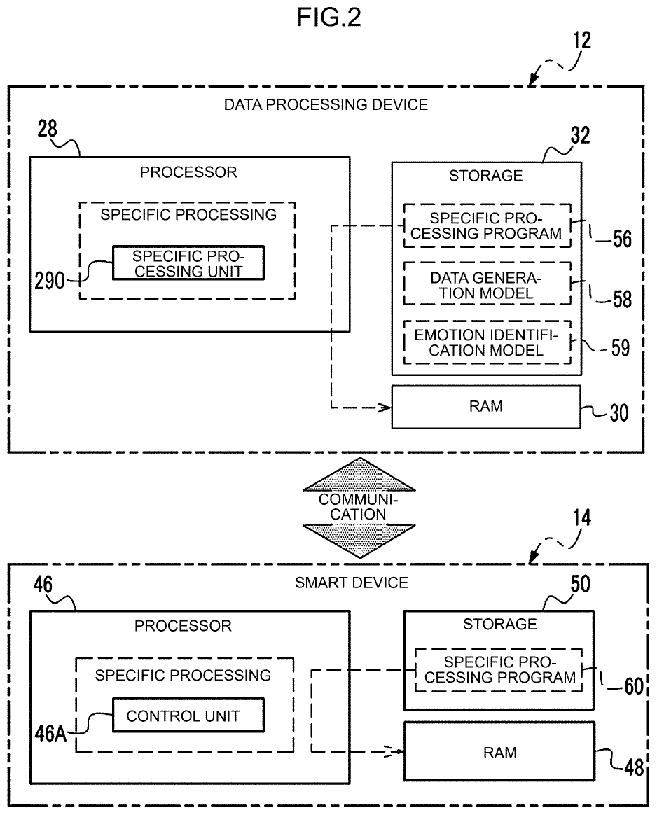

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The kitting procedure manual automatic creation system according to the embodiment of the present invention is a system that automates the creation of procedure manuals for performing kitting work. This system comprises: a reception unit configured to input a kitting item name; a generation unit configured to generate a response based on the item name input by the reception unit; an input unit configured to input the response generated by the generation unit into a master template; and a creation unit configured to automatically create a kitting procedure manual based on the master input by the input unit. For example, by inputting the kitting item name into the generative AI and having the generative AI input the response into the master template, the man-hours required for master creation can be reduced. Next, in the creation of the kitting procedure manual, by inputting the kitting item name, the created master can be called and the kitting procedure manual can be automatically created. For example, by inputting item names such as “network settings” or “software installation,” the procedure manual can be automatically created based on the master created by the generative AI. As a result, the man-hours required for procedure manual creation can be greatly reduced. Through this mechanism, the efficiency of kitting work is improved, and the man-hours required for procedure manual creation can be reduced. For example, by automating the procedure manual creation work that was conventionally performed manually, it is expected that work time will be shortened and errors will be reduced. Furthermore, by using generative AI, the quality of the procedure manual can also be improved. Thus, the kitting procedure manual automatic creation system can improve the efficiency of kitting work and reduce the man-hours required for procedure manual creation. Specifically, when the reception unit receives a kitting item name (e.g., “network settings,” “software installation,” “printer settings,” etc.) from a user, it can accept input data such as a text string (UTF-8 encoded, up to 256 characters) or audio data (16 kHz, 16 bit PCM, mono). The reception unit normalizes the input data (e.g., full-width/half-width conversion, removal of unnecessary symbols, conversion to text via speech recognition) and passes it to the generation unit. The generation unit, for example, uses a transformer-based large language model (with parameters ranging from 1 billion to 100 billion), tokenizes the input item name (e.g., subword segmentation, up to 128 tokens), and inputs it into a pre-trained model that has learned from past procedure manual data (e.g., JSON-format procedure manual structures with fields such as “title,” “detailed description,” “cautions” for each procedure) and user feedback (e.g., 5-level ratings, comment text) as training data. The generation unit outputs procedure manual fragments corresponding to each item name (e.g., “network settings”→“1. Open the control panel. 2. Select Network and Internet. 3. Change adapter settings.”), and assigns a score (e.g., confidence 0.92) and recommendation label (e.g., “Recommended,” “Needs confirmation”). The input unit automatically maps and inputs the procedure manual fragments received from the generation unit into designated fields of an Excel template (e.g., .xlsx format, each row as a procedure, columns as item attributes) or a relational database (e.g., PostgreSQL, table “procedure_master”). The input unit also performs data integrity verification (e.g., checking for missing required items, duplicate elimination) and version management (e.g., adding timestamps, recording to a history table). The creation unit receives a list of kitting item names specified by the user based on the master data constructed by the input unit, automatically concatenates related procedure manual fragments according to the template, and outputs them in formats such as PDF (e.g., A4 portrait, 12 pt font, automatic table of contents generation), HTML, or Markdown. The creation unit can also perform layout optimization (e.g., adjusting page break positions, automatic insertion of figures and tables), multilingual support (e.g., automatic translation into English and Chinese), and accessibility support (e.g., adding tags for voice reading) at the time of output. These series of processes utilize parallel computing clusters with GPUs and distributed storage, achieving significant improvements in processing speed (e.g., 10 minutes per case→30 seconds), elimination of human error, and standardization and uniformity of procedure manual quality compared to conventional manual procedure manual creation. As a technical effect, this system not only automates human work, but also combines high-dimensional feature extraction, pattern learning, and rule-based generation by AI, enabling rapid response to large volumes and diverse kitting patterns, flexible adaptation to customization requests for each user, and applicability in a wide range of fields such as IT equipment deployment sites, large-scale SI projects, PC setup in educational institutions, and initial setup procedure manual creation for medical devices.

The kitting procedure manual automatic creation system according to the embodiment comprises a reception unit, a generation unit, an input unit, and a creation unit. The reception unit inputs a kitting item name. For example, the reception unit can input item names such as “network settings” or “software installation.” The generation unit uses a generative AI to generate a response based on the item name input by the reception unit. For example, the generation unit inputs the item name “network settings” into the generative AI, and the generative AI generates specific setting procedures. The generation unit generates a response based on the algorithm or training data of the generative AI. For example, the generation unit uses a neural network or transformer model of the generative AI, learns from past procedure manual data and user feedback data, and generates a response. The input unit inputs the response generated by the generation unit into a master template. For example, the input unit inputs the generated response into an Excel sheet or database-format master template. The creation unit automatically creates a kitting procedure manual based on the master input by the input unit. For example, the creation unit can automatically create a procedure manual based on the created master by inputting the kitting item name. The creation unit provides the generated procedure manual to the user. For example, the creation unit outputs the generated procedure manual in PDF format and provides it to the user. Thus, the kitting procedure manual automatic creation system according to the embodiment can automate the creation of kitting procedure manuals and improve work efficiency. Specifically, when the reception unit receives a kitting item name from a user, it can accept input data such as a text string (UTF-8 encoded, up to 256 characters) or audio data (16 kHz, 16 bit PCM, mono). The reception unit normalizes the input data (full-width/half-width conversion, removal of unnecessary symbols, conversion to text via speech recognition) and passes it to the generation unit. The generation unit, for example, uses a transformer-based large language model (with parameters ranging from 1 billion to 100 billion), tokenizes the input item name (subword segmentation, up to 128 tokens), and inputs it into a pre-trained model that has learned from past procedure manual data (JSON-format procedure manual structures with fields such as “title,” “detailed description,” “cautions” for each procedure) and user feedback (5-level ratings, comment text) as training data. The generation unit outputs procedure manual fragments corresponding to each item name (e.g., “network settings”→“1. Open the control panel. 2. Select Network and Internet. 3. Change adapter settings.”), and assigns a score (confidence 0.92) and recommendation label (“Recommended,” “Needs confirmation”). The input unit automatically maps and inputs the procedure manual fragments received from the generation unit into designated fields of an Excel template (.xlsx format, each row as a procedure, columns as item attributes) or a relational database (PostgreSQL, table “procedure_master”). The input unit also performs data integrity verification (checking for missing required items, duplicate elimination) and version management (adding timestamps, recording to a history table). The creation unit receives a list of kitting item names specified by the user based on the master data constructed by the input unit, automatically concatenates related procedure manual fragments according to the template, and outputs them in formats such as PDF (A4 portrait, 12 pt font, automatic table of contents generation), HTML, or Markdown. The creation unit can also perform layout optimization (adjusting page break positions, automatic insertion of figures and tables), multilingual support (automatic translation into English and Chinese), and accessibility support (adding tags for voice reading) at the time of output. These series of processes utilize parallel computing clusters with GPUs and distributed storage, achieving significant improvements in processing speed (10 minutes per case→30 seconds), elimination of human error, and standardization and uniformity of procedure manual quality compared to conventional manual procedure manual creation. As a technical effect, this system not only automates human work, but also combines high-dimensional feature extraction, pattern learning, and rule-based generation by AI, enabling rapid response to large volumes and diverse kitting patterns, flexible adaptation to customization requests for each user, and applicability in a wide range of fields such as IT equipment deployment sites, large-scale SI projects, PC setup in educational institutions, and initial setup procedure manual creation for medical devices.

The generation unit can generate specific setting procedures based on the item name using a generative AI. For example, the generation unit inputs the item name “network settings” into the generative AI, and the generative AI generates specific setting procedures. The generative AI, for example, uses a text generation AI (e.g., GPT-3) or transformer model to generate specific setting procedures based on the item name. The generative AI learns from past procedure manual data and user feedback data to generate specific setting procedures based on the item name. For example, the generative AI generates specific setting procedures for the item name “network settings” and provides them to the generation unit. Thus, by using a generative AI, specific setting procedures can be automatically generated. Specifically, the generation unit receives as input tokenized item names (e.g., “network settings”→[‘network’, ‘settings’]) and related additional information (e.g., user's past selection tendencies, project attribute vectors, etc.). The generation unit inputs these into a multi-layer transformer-type neural network (12 encoder layers, 12 decoder layers, 6 billion parameters), and extracts the relationship between item names and past data in a high-dimensional space using a self-attention mechanism. The generation unit outputs procedure manual fragments (e.g., “1. Open the control panel. 2. Select Network and Internet. 3. Change adapter settings.”), assigns a confidence score (e.g., 0.93), and a recommendation label (e.g., “Recommended”). The generation unit uses the output results for threshold judgment (e.g., only automatically adopting those with confidence of 0.8 or higher) or as a trigger for retraining based on user feedback. During training, the generation unit uses a cross-entropy loss function and employs past procedure manual data (JSON structures with fields such as “title,” “detailed description,” “cautions” for each procedure) and user evaluation data (5-level ratings, comment text) as training data. For data augmentation, synonym replacement and shuffling of procedure order are performed to improve the generalization performance of the model. As a technical effect, the generation unit does not simply imitate humans, but learns patterns and rules extracted from vast past data in a high-dimensional space, enabling rapid response to diverse kitting patterns and flexible adaptation to customization requests for each user, which was previously difficult. Application fields include IT equipment deployment sites, large-scale SI projects, PC setup in educational institutions, and initial setup procedure manual creation for medical devices.

The input unit can input the generated response into a master template. For example, the input unit inputs the generated response into an Excel sheet or database-format master template. The input unit can automatically input the generated response into the master template. For example, the input unit inputs the generated response into a specific cell of an Excel sheet. Additionally, the input unit can input the generated response into a specific field of a database-format master template. Thus, the generated response can be automatically input into the master template. Specifically, the input unit automatically maps and inputs the procedure manual fragments received from the generation unit (e.g., JSON-format structures with fields such as “title,” “detailed description,” “cautions”) into designated fields of an Excel template (.xlsx format, each row as a procedure, columns as item attributes) or a relational database (PostgreSQL, table “procedure_master”). During input, the input unit performs data integrity verification (checking for missing required items, duplicate elimination), version management (adding timestamps, recording to a history table), and automatic recovery in case of input errors (e.g., re-input request upon detection of invalid data). As an input algorithm, the input unit applies different mapping rules according to the category of the template (e.g., network settings, software installation, hardware settings), achieving data placement optimized for each category. The input unit assigns importance scores and relevance labels to the input content, which are used for priority control during procedure manual generation by the subsequent creation unit. As a technical effect, the input unit realizes improvements in computer technology itself, such as elimination of input errors, automatic assurance of data integrity, automation of history management, and improved data reusability between templates, compared to manual input by humans. Application fields include large-scale procedure manual management for IT equipment deployment sites, standardized procedure manual creation for educational institutions, and safety management procedure manual creation for medical devices.

The creation unit can automatically create a procedure manual based on the created master by inputting the kitting item name. For example, the creation unit can automatically create a procedure manual based on the created master by inputting the kitting item name. The creation unit provides the generated procedure manual to the user. For example, the creation unit outputs the generated procedure manual in PDF format and provides it to the user. The creation unit can automatically create and provide the generated procedure manual to the user. For example, the creation unit can automatically create a procedure manual based on the created master by inputting the kitting item name and output it in PDF format. Thus, by simply inputting the kitting item name, the procedure manual can be automatically created. Specifically, the creation unit receives a list of kitting item names specified by the user (e.g., [‘network settings’, ‘software installation’]) based on the master data constructed by the input unit (e.g., Excel template, database table), automatically concatenates related procedure manual fragments according to the template, and selects output formats such as PDF (A4 portrait, 12 pt font, automatic table of contents generation), HTML, or Markdown. The creation unit performs layout optimization (adjusting page break positions, automatic insertion of figures and tables), multilingual support (automatic translation into English and Chinese), and accessibility support (adding tags for voice reading) at the time of output. The creation unit dynamically adjusts the order and level of detail of procedures based on the importance and relevance of the procedure manual, generating customized procedure manuals according to user requirements. The creation unit records the output results in a history management system, enabling version management and difference comparison. As a technical effect, the creation unit achieves significant improvement in creation speed (10 minutes per case→30 seconds), elimination of human error, and standardization and uniformity of procedure manual quality compared to conventional manual procedure manual creation. Application fields include IT equipment deployment sites, large-scale SI projects, PC setup in educational institutions, and initial setup procedure manual creation for medical devices.

The generation unit can generate a response based on the algorithm or training data of the generative AI. For example, the generation unit generates a response based on the algorithm or training data of the generative AI. The algorithm of the generative AI is implemented using technologies such as neural networks or transformer models. The training data of the generative AI includes, for example, past procedure manual data and user feedback data. The generation unit generates specific setting procedures for the item name based on the algorithm or training data of the generative AI. For example, the generation unit uses a neural network of the generative AI to learn from past procedure manual data and generate specific setting procedures based on the item name. Thus, by generating a response based on the algorithm or training data of the generative AI, highly accurate procedure manuals can be created. Specifically, the generation unit receives as input tokenized item names (e.g., “network settings”→[‘network’, ‘settings’]) and related additional information (e.g., category vectors representing user's past selection tendencies, project attribute vectors, time information vectors, all as 32-128 dimensional numerical arrays). The generation unit inputs these into a multi-layer transformer-type neural network (12 encoder layers, 12 decoder layers, 6 billion parameters, GELU activation function, 16 self-attention heads), and extracts the relationship between item names and past data in a high-dimensional space using a self-attention mechanism. During training, the generation unit uses a cross-entropy loss function and employs past procedure manual data (JSON structures with fields such as “title,” “detailed description,” “cautions” for each procedure) and user evaluation data (5-level ratings, comment text) as training data. For data augmentation, synonym replacement, shuffling of procedure order, and noise addition are performed to improve the generalization performance of the model. The generation unit outputs procedure manual fragments (e.g., “1. Open the control panel. 2. Select Network and Internet. 3. Change adapter settings.”), assigns a confidence score (e.g., 0.93), and a recommendation label (e.g., “Recommended”). The output data is output as a JSON-format structure (fields: title, description, caution, score, label, etc.). For example, input “network settings”+project attribute vector→output “1. Open the control panel. 2. Select Network and Internet. 3. Change adapter settings.”+score: 0.93+label: Recommended; input “software installation”+user tendency vector→output “1. Download the installer. 2. Double-click the executable file. 3. Follow the instructions to install.”+score: 0.91+label: Needs confirmation, etc. The generation unit uses the output results for threshold judgment (e.g., only automatically adopting those with confidence of 0.8 or higher) or as a trigger for retraining based on user feedback. Thus, the generation unit does not simply imitate humans, but learns patterns and rules extracted from vast past data in a high-dimensional space, enabling rapid response to diverse kitting patterns and flexible adaptation to customization requests for each user. As a technical effect, the generation unit achieves highly accurate procedure manual generation, fast response, elimination of human error, and standardization and uniformity of procedure manual quality, which were difficult to achieve with conventional manual rule description or simple template matching. Application fields include IT equipment deployment sites, large-scale SI projects, PC setup in educational institutions, and initial setup procedure manual creation for medical devices, greatly contributing to work efficiency and quality improvement in these fields.

The creation unit can provide the generated procedure manual to the user. For example, the creation unit outputs the generated procedure manual in PDF format and provides it to the user. The creation unit can automatically create and provide the generated procedure manual to the user. For example, the creation unit outputs the generated procedure manual in PDF format and provides it to the user. Additionally, the creation unit can provide the generated procedure manual to the user via web applications or mobile applications. For example, the creation unit displays the generated procedure manual in a web application for the user to view. Thus, by providing the generated procedure manual to the user, the use of the procedure manual becomes easier. Specifically, the creation unit receives a list of kitting item names specified by the user (e.g., [‘network settings’, ‘software installation’]) based on the master data constructed by the input unit (e.g., Excel template, database table), automatically concatenates related procedure manual fragments according to the template, and selects output formats such as PDF (A4 portrait, 12 pt font, automatic table of contents generation), HTML, Markdown, JSON, or XML. The creation unit performs layout optimization (adjusting page break positions, automatic insertion of figures and tables, column control), multilingual support (automatic translation into English, Chinese, Spanish, etc.), and accessibility support (adding tags for voice reading, color barrier-free color schemes) at the time of output. The creation unit dynamically adjusts the order and level of detail of procedures based on the importance and relevance of the procedure manual, generating customized procedure manuals according to user requirements. The creation unit records the output results in a history management system, enabling version management and difference comparison. For example, the creation unit automatically generates a table of contents, page numbers, and figure/table lists when outputting PDF, and adds responsive design and interactive procedure expansion functions when outputting HTML. For mobile applications, touch operation optimization and offline viewing functions are implemented. The creation unit can also link output data with other systems (e.g., asset management systems, help desk systems) via API. As a technical effect, the creation unit achieves significant improvement in creation speed (10 minutes per case→30 seconds), elimination of human error, standardization and uniformity of procedure manual quality, and improved usability through multi-device and multi-format support compared to conventional manual procedure manual creation. Application fields include IT equipment deployment sites, large-scale SI projects, PC setup in educational institutions, initial setup procedure manual creation for medical devices, and mobile manual distribution for field workers, greatly contributing to work efficiency and quality improvement in these fields.

The reception unit can estimate a user's emotion and adjust the timing of inputting the kitting item name based on the estimated emotion of the user. For example, the reception unit estimates a user's emotion and adjusts the timing of inputting the kitting item name based on the estimated emotion. Emotion estimation is realized using an emotion estimation function, for example, by employing an emotion engine or generative AI. The generative AI may be a text generation AI (e.g., LLM) or a multimodal generative AI, but is not limited to these examples. For instance, when the user is feeling stressed, the reception unit provides a simple interface and minimizes the input steps. When the user is relaxed, the reception unit can provide detailed input options and suggest customizable input methods. Furthermore, when the user is in a hurry, the reception unit can prioritize voice input to enable quick input of the kitting item name. Thus, by adjusting the input timing according to the user's emotion, the user's burden can be reduced. Specifically, the reception unit receives user input data (e.g., audio data 16 kHz 16 bit PCM, text string UTF-8 up to 256 characters, facial image 128×128 pixels RGB, mouse/touch operation logs, etc.) and inputs it into an emotion estimation AI (e.g., multimodal neural network, transformer-based integration of audio, text, and image features, 500 million parameters). The emotion estimation AI extracts features such as audio pitch, speed, intonation, positive/negative vocabulary in text, facial feature points, and operation speed, and outputs emotion labels (e.g., stress, relaxation, excitement, impatience) and confidence scores (e.g., 0.85). For example, audio input “I want to finish quickly”+facial image (frowning)→output “stress”+0.92; text input “I want to proceed slowly”+operation log (low speed)→output “relaxation”+0.88, etc. The reception unit inputs the output results of the emotion estimation AI into the UI display control module, dynamically adjusting input timing, procedures, and UI configuration, such as minimizing the number of input items during stress, emphasizing the voice input button when in a hurry, and expanding detailed options when relaxed. During training, the emotion estimation AI uses a teacher dataset combining audio, text, image, and operation logs (e.g., 10,000 cases, each data labeled with emotion) and optimizes with a cross-entropy loss function. As a technical effect, the reception unit achieves dynamic input timing control according to user status, reduction of user burden, and reduction of input errors and dropout rates, which were difficult to realize with conventional static UIs and uniform input procedures. Application fields include input support for field workers in IT equipment deployment sites, setup support for beginners in educational institutions, and input of safety management procedures for medical devices, contributing to improved user experience and work efficiency.

The reception unit can analyze a user's past input history and select an appropriate input method. For example, the reception unit analyzes a user's past input history and selects the optimal input method. The reception unit can use a generative AI to analyze a user's past input history and select an appropriate input method. For instance, the reception unit automatically displays frequently input kitting item names as candidates based on the user's past input history. Additionally, the reception unit can preferentially suggest input methods (voice, text, etc.) that the user has used in the past. Furthermore, the reception unit can predict and suggest kitting item names used at specific times based on the user's past input history. Thus, by analyzing past input history, the optimal input method can be provided. Specifically, the reception unit maintains an input history database for each user (e.g., a structure recording input time, input method, item name, input duration, input success/failure, etc.), and inputs history data (e.g., the most recent 100 input sequences, each sequence as a vector of input method ID, item name ID, time, success flag, etc.) into an analysis AI (e.g., time-series LSTM network, 1 million parameters). The analysis AI extracts frequently used item names (e.g., input 5 times or more in the past week), input method tendencies (e.g., 70% voice input, 30% text input), and usage patterns by time of day (e.g., “network settings” in the morning, “software installation” in the afternoon) from the input sequences, and outputs recommended input methods (e.g., voice, text, template selection, etc.) and candidate item name lists (e.g., top 3 by frequency). For example, user A's history: “5 times network settings by voice input, 2 times printer settings by text input”→recommendation: “voice input +network settings”; user B's history: “3 times software installation in the afternoon”→recommendation: “display software installation as a candidate in the afternoon,” etc. The reception unit inputs the output results of the analysis AI into the UI control module, automatically selecting the recommended input method as default, displaying candidate item names as suggestions, and switching candidates according to time of day. During training, the analysis AI uses a cross-entropy loss function and time-series prediction error function, optimizing with history data and actual selection results as training data. As a technical effect, the reception unit achieves input support optimized for each user's usage tendencies, improved input efficiency, and reduction of input errors and rework, which were difficult to realize with conventional static candidate displays and uniform input method suggestions. Application fields include input support for field workers in IT equipment deployment sites, standardized procedure manual creation for educational institutions, and input of safety management procedures for medical devices, contributing to improved user experience and work efficiency.

The reception unit can perform filtering based on the user's current project or area of interest when inputting the kitting item name. For example, the reception unit performs filtering based on the user's current project or area of interest when inputting the kitting item name. The reception unit can use a generative AI to perform filtering based on the user's current project or area of interest. For instance, the reception unit preferentially displays kitting item names related to the project the user is currently working on. Additionally, the reception unit can suggest highly relevant kitting item names based on the user's area of interest. Furthermore, the reception unit can analyze the user's past project history and automatically display related kitting item names. Thus, by performing filtering based on the current project or area of interest, highly relevant item names can be provided. Specifically, the reception unit maintains a project attribute database for each user (e.g., a structure with project ID, category, start date, progress status, area of interest tags, etc.), and obtains the current project ID and area of interest tags (e.g., network, security, education, medical, etc.) at the time of input. The reception unit inputs the current project attributes and candidate item name list into a filtering AI (e.g., multilayer perceptron, input: project attribute vector+item name attribute vector, output: relevance score 0.0-1.0), and displays only item names with high relevance scores as candidates. For example, project attribute “educational institution PC setup”+item name “network settings”→relevance 0.95; “medical device initial setup”+item name “virus protection”→relevance 0.92, etc. The reception unit inputs the output results of the filtering AI into the UI control module, automatically displaying only item names with relevance 0.8 or higher as suggestions, and switching candidates according to area of interest tags. During training, the filtering AI uses project attributes, item names, and actual selection history as training data, optimizing with a cross-entropy loss function. As a technical effect, the reception unit achieves input support optimized for each project and area, presentation of highly relevant item names, and improved input efficiency, which were difficult to realize with conventional static candidate displays and uniform item name suggestions. Application fields include project management for IT equipment deployment sites, standardized procedure manual creation for educational institutions, and input of safety management procedures for medical devices, contributing to improved user experience and work efficiency.

The reception unit can estimate a user's emotion and determine the priority of kitting item names to be input based on the estimated emotion of the user. For example, the reception unit estimates a user's emotion and determines the priority of kitting item names to be input based on the estimated emotion. Emotion estimation is realized using an emotion estimation function, for example, by employing an emotion engine or generative AI. The generative AI may be a text generation AI (e.g., LLM) or a multimodal generative AI, but is not limited to these examples. For instance, when the user is feeling stressed, the reception unit prioritizes input of highly important kitting item names. When the user is relaxed, the reception unit can provide detailed input options and suggest customizable input methods. Furthermore, when the user is in a hurry, the reception unit can quickly display highly important kitting item names for input. Thus, by determining the priority of input items according to the user's emotion, efficient input becomes possible. Specifically, the reception unit inputs user data such as audio data (16 kHz 16 bit PCM), text string (UTF-8 up to 256 characters), facial image (128×128 pixels RGB), and mouse/touch operation logs (time-series vectors including operation type, coordinates, speed, etc. for each time point) into an emotion estimation AI. The emotion estimation AI uses a multimodal neural network (transformer-based, 500 million parameters, integrating feature extraction subnetworks for audio, text, image, and operation logs), extracts features such as audio pitch, speed, intonation, frequency of positive/negative vocabulary in text, facial feature points (e.g., mouth corners, frown, eye opening), and operation speed/frequency, and outputs emotion labels (e.g., stress, relaxation, excitement, impatience) and confidence scores (e.g., 0.87). For example, audio input “I'm in a hurry”+facial image (wide-open eyes)+fast mouse operation→output “impatience”+0.91; text input “I want to proceed calmly”+slow operation→output “relaxation”+0.89, etc. The reception unit assigns importance scores (e.g., numerical values from 0.0 to 1.0 considering past work frequency, relevance to project attribute vectors, user-specified priority, etc.) to the candidate list of kitting item names (e.g., 10 items) based on the output results of the emotion estimation AI, and applies a priority determination algorithm for each emotional state (e.g., stress: importance×urgency weighting, relaxation: emphasis on customizability, impatience: minimize number of input steps). The reception unit passes the prioritized item name list to the UI control module, dynamically controlling the input interface, such as displaying only the top 3 items as large buttons during stress, expanding detailed options during relaxation, and emphasizing the voice input button when in a hurry. During training, the emotion estimation AI uses a teacher dataset combining audio, text, image, and operation logs (e.g., 20,000 cases, each data labeled with emotion and confidence) and optimizes with a cross-entropy loss function. As a technical effect, the reception unit achieves dynamic input item priority control according to user status, reduction of user burden, and reduction of input errors and dropout rates, which were difficult to realize with conventional static candidate displays and uniform input order. Application fields include input support for field workers in IT equipment deployment sites, setup support for beginners in educational institutions, and input of safety management procedures for medical devices, contributing to improved user experience and work efficiency.

The reception unit can preferentially input relevant kitting item names by considering the user's geographic location information when inputting the kitting item name. For example, the reception unit preferentially inputs relevant kitting item names by considering the user's geographic location information when inputting the kitting item name. The reception unit can use a generative AI to preferentially input relevant kitting item names by considering the user's geographic location information. For instance, when the user is in a specific region, the reception unit preferentially displays kitting item names related to that region. Additionally, the reception unit can suggest highly relevant kitting item names based on the user's current location. Furthermore, the reception unit can analyze the user's past movement history and automatically display related kitting item names. Thus, by considering geographic location information, highly relevant item names can be provided. Specifically, the reception unit normalizes geographic location data obtained from the user's device, such as GPS coordinates (latitude, longitude, accuracy within 5 m), Wi-Fi access point information, and IP address, into a location information vector (e.g., 8-16 dimensional numerical array including latitude, longitude, region code, facility ID, etc.). The reception unit inputs the location information vector and candidate kitting item name list (each item name assigned a region attribute vector and past region-specific usage frequency score) into a filtering AI (multilayer perceptron, input: location information vector+item name attribute vector, output: relevance score 0.0-1.0). The filtering AI calculates the degree of match between the current location and the region attributes of the item name, past region-specific usage records, and facility type (e.g., school, hospital, office, etc.) in a high-dimensional space, and outputs a relevance score. For example, current location “Chiyoda-ku, Tokyo”+item name “network settings”→relevance 0.95; current location “Osaka city”+item name “printer settings”→relevance 0.88, etc. The reception unit passes only item names with high relevance scores to the UI control module, dynamically controlling candidate display and suggestion order. Furthermore, the reception unit inputs the user's past movement history (e.g., location information logs for the past 30 days, input item name history for each location) into a time-series LSTM network, extracts usage tendencies by region, and utilizes them for predicting candidate item names for the next input. During training, the filtering AI uses location information, item names, and actual selection history as training data, optimizing with a cross-entropy loss function. As a technical effect, the reception unit achieves input support optimized for each region and facility, presentation of highly relevant item names, and improved input efficiency, which were difficult to realize with conventional static candidate displays and uniform item name suggestions. Application fields include multi-site deployment for IT equipment, region-specific standardized procedure manual creation for educational institutions, and facility-specific safety management procedure input for medical devices, contributing to improved user experience and enhanced field adaptability.

The reception unit can input related kitting item names by analyzing the user's social media activity when inputting the kitting item name. For example, the reception unit inputs related kitting item names by analyzing the user's social media activity when inputting the kitting item name. The reception unit can use a generative AI to input related kitting item names by analyzing the user's social media activity. For instance, the reception unit analyzes the content of the user's social media posts and suggests related kitting item names. Additionally, the reception unit can display highly relevant kitting item names based on the user's follow and like history on social media. Furthermore, the reception unit can analyze the user's social media activity history and automatically display related kitting item names. Thus, by analyzing social media activity, highly relevant item names can be provided. Specifically, the reception unit converts social media post data obtained within the permitted scope by the user (e.g., latest 100 post texts, post times, hashtags, follow/like history, image attachment information, etc.) into structured data such as text strings (UTF-8 up to 512 characters), category ID vectors (e.g., interest area tags, followee categories), and time-series post frequency vectors (number of posts per 24 hours×7 days). The reception unit inputs these data into an analysis AI (transformer-based large language model, 1 billion parameters, integrated text, category, and time-series features), vectorizes keywords, topic topics, and interest area distributions (e.g., network, security, education, medical, etc.) extracted from post content in a high-dimensional space. The analysis AI calculates cosine similarity and relevance scores (0.0-1.0) between the candidate kitting item name list (each item name assigned a field attribute vector and past selection frequency score) and the user's interest area vector, and displays highly relevant item names at the top. For example, post content “network failure response,” “new printer introduction”→candidates “network settings,” “printer settings” relevance 0.93; follow history “many security-related accounts”→candidate “virus protection” relevance 0.91, etc. The reception unit inputs the output results of the analysis AI into the UI control module, automatically displaying item names with high relevance, and switching candidates according to interest area. During training, the analysis AI uses post data, interest areas, and actual item name selection history as training data, optimizing with a cross-entropy loss function. As a technical effect, the reception unit achieves input support that promptly responds to the user's latest interests, presentation of highly relevant item names, and improved input efficiency, which were difficult to realize with conventional static candidate displays and uniform item name suggestions. Application fields include input support for field workers in IT equipment deployment sites, standardized procedure manual creation for educational institutions, and input of safety management procedures for medical devices, contributing to improved user experience and work efficiency.

The generation unit can estimate a user's emotion and adjust the expression method of the generated procedure based on the estimated emotion of the user. For example, the generation unit estimates a user's emotion and adjusts the expression method of the generated procedure based on the estimated emotion. Emotion estimation is realized using an emotion estimation function, for example, by employing an emotion engine or generative AI. The generative AI may be a text generation AI (e.g., LLM) or a multimodal generative AI, but is not limited to these examples. For instance, when the user is relaxed, the generation unit generates procedures that proceed at a leisurely pace. When the user is in a hurry, the generation unit can generate procedures that emphasize the shortest route. Furthermore, when the user is excited, the generation unit can generate procedures with visually stimulating effects. Thus, by adjusting the expression method of the procedure according to the user's emotion, procedures that are easy for the user to understand can be provided. Specifically, the generation unit receives emotion labels (e.g., relaxation, hurry, excitement, etc.) and confidence scores (e.g., 0.85) from the reception unit as additional context for the generative AI. The generation unit inputs tokenized item names (e.g., “network settings”→[‘network’, ‘settings’]), project attribute vectors (e.g., 32 dimensions), user emotion labels (one-hot encoding), and past procedure manual data (JSON structures with fields such as “title,” “detailed description,” “cautions” for each procedure) into a multi-layer transformer-type neural network (12 encoder layers, 12 decoder layers, 6 billion parameters). The generation unit dynamically changes decoder output control parameters (e.g., style temperature, explanation detail level, effect insertion flag, etc.) according to the emotion label, adjusting the expression method of procedure manual fragments, such as providing more detailed explanations and supplementary information during relaxation, minimizing the number of procedures and emphasizing key points during hurry, and adding emphasis expressions and color tags during excitement. For example, input “network settings”+emotion “relaxation”→output “1. Let's slowly open the control panel. 2. Select Network and Internet. 3. Check detailed settings as needed.”; input “network settings”+emotion “hurry”→output “1. Open the control panel. 2. Change network settings immediately.”; input “network settings”+emotion “excitement”→output “1. Open the control panel and dive into the world of networks! (effect tag attached),” etc. The generation unit outputs the results as JSON-format structures (fields: title, description, effect, score, label, etc.), which are used for layout control and effect display in subsequent input and creation units. During training, the generation unit uses a procedure manual dataset with emotion labels (e.g., 10,000 cases, each procedure with expression variations for each emotion) as training data, optimizing with a cross-entropy loss function. As a technical effect, the generation unit achieves expression optimization according to user status, improved comprehension, and reduced work stress, which were difficult to realize with conventional uniform procedure manual generation. Application fields include procedure manual generation for field workers in IT equipment deployment sites, manual creation for beginners in educational institutions, and safety management procedure manual creation for medical devices, contributing to improved user experience and work efficiency.

The generation unit can adjust the level of detail of the generated procedure based on the importance of the item name during generation. For example, the generation unit adjusts the level of detail of the generated procedure based on the importance of the item name during generation. The generation unit can use a generative AI to adjust the level of detail of the generated procedure based on the importance of the item name. For instance, the generation unit generates detailed procedures for highly important item names. Additionally, the generation unit can generate concise procedures for less important item names. Furthermore, the generation unit can dynamically adjust the level of detail of procedures according to the importance of the item name. Thus, by adjusting the level of detail of procedures based on the importance of the item name, appropriate procedures can be provided. Specifically, the generation unit utilizes importance scores for each item name (e.g., 0.0-1.0, considering past failure frequency, business impact, user-specified priority, etc.) received from the reception unit or project management system as additional input for the generative AI. The generation unit inputs tokenized item names, project attribute vectors, importance scores (continuous values or category labels), and past procedure manual data (JSON structures) into a multi-layer transformer-type neural network (12 encoder layers, 12 decoder layers, 6 billion parameters). The generation unit dynamically changes decoder output control parameters (e.g., explanation detail level, number of procedures, inclusion of cautions, etc.) according to the importance score, generating more detailed explanations, supplementary information, and cautions for high importance, and concise procedures focusing only on key points for low importance. For example, input “network settings”+importance 0.95→output “1. Open the control panel. 2. Select Network and Internet. 3. Change adapter settings. 4. Check security settings. 5. Restart is recommended after setting.”; input “printer settings”+importance 0.40→output “1. Connect the printer. 2. Install the driver,” etc. The generation unit outputs the results as JSON-format structures (fields: title, description, caution, score, label, etc.), which are used for detail control and layout adjustment in subsequent input and creation units. During training, the generation unit uses a procedure manual dataset with importance labels (e.g., 10,000 cases, each procedure with variations by importance) as training data, optimizing with a cross-entropy loss function. As a technical effect, the generation unit achieves optimization of detail according to business impact and field requirements, reduction of work errors, and improved comprehension, which were difficult to realize with conventional uniform procedure manual generation. Application fields include procedure manual generation for field workers in IT equipment deployment sites, standardized manual creation for educational institutions, and safety management procedure manual creation for medical devices, contributing to field adaptability and quality improvement.

The generation unit can apply different generation algorithms according to the category of the item name during generation. For example, the generation unit applies different generation algorithms according to the category of the item name during generation. The generation unit can use a generative AI to apply different generation algorithms according to the category of the item name. For instance, the generation unit applies a network-related generation algorithm for item names related to network settings. Additionally, the generation unit can apply a software-related generation algorithm for item names related to software installation. Furthermore, the generation unit can apply a hardware-related generation algorithm for item names related to hardware settings. Thus, by applying appropriate generation algorithms according to the category of the item name, highly accurate procedures can be provided. Specifically, the generation unit controls the algorithm selection module of the generative AI based on category IDs for each item name (e.g., integer labels or one-hot vectors for network, software, hardware, etc.) received from the reception unit. The generation unit receives tokenized item names, category IDs, project attribute vectors, and past procedure manual data (category-specific subsets) as input, and automatically selects the optimal generation algorithm for each category (e.g., network settings: rule-based+transformer hybrid; software installation: procedure template+large language model; hardware settings: image recognition AI+procedure generation AI collaboration). For example, in the network settings category, rule-based determination of network configuration patterns (e.g., automatic IP address assignment, VLAN setting branching) is combined with natural language generation; in the software installation category, template expansion considering installer type, OS version, and dependencies is supplemented by AI; in the hardware settings category, image input (e.g., wiring photo 128×128 pixels RGB) is analyzed by CNN and input to the procedure generation AI, implementing different processing flows for each category. The generation unit outputs category-optimized procedure manual fragments (JSON format, fields: title, description, category, score, label, etc.), which are used for detail control and layout adjustment in subsequent input and creation units. During training, the generation unit uses category-specific procedure manual datasets (e.g., 10,000 cases per category, with category-specific rules and expression variations) as training data, optimizing with a cross-entropy loss function. As a technical effect, the generation unit achieves optimization according to business requirements and field characteristics for each category, high-precision procedure generation, and reduction of work errors, which were difficult to realize with conventional uniform procedure manual generation and simple template matching. Application fields include procedure manual generation for diverse categories in IT equipment deployment sites, field-specific manual creation for educational institutions, and category-specific safety management procedure manual creation for medical devices, contributing to field adaptability and quality improvement.

The generation unit can estimate a user's emotion and adjust the length of the generated procedure based on the estimated emotion of the user. For example, the generation unit estimates a user's emotion and adjusts the length of the generated procedure based on the estimated emotion. Emotion estimation is realized using an emotion estimation function, for example, by employing an emotion engine or generative AI. The generative AI may be a text generation AI (e.g., LLM) or a multimodal generative AI, but is not limited to these examples. For instance, when the user is in a hurry, the generation unit generates short procedures that focus on key points. When the user is relaxed, the generation unit can generate longer procedures with detailed explanations. Furthermore, when the user is excited, the generation unit can generate procedures with visually stimulating effects. Thus, by adjusting the length of the procedure according to the user's emotion, appropriate procedures can be provided to the user. Specifically, the generation unit receives emotion labels (e.g., hurry, relaxation, excitement, etc.) and confidence scores (e.g., 0.88) from the reception unit as additional context for the generative AI. The generation unit inputs tokenized item names, project attribute vectors, user emotion labels (one-hot encoding), and past procedure manual data (JSON structures) into a multi-layer transformer-type neural network (12 encoder layers, 12 decoder layers, 6 billion parameters). The generation unit dynamically changes decoder output control parameters (e.g., maximum number of procedures, explanation detail level, effect insertion flag, etc.) according to the emotion label, adjusting the length and expression of procedure manual fragments, such as minimizing the number of procedures and emphasizing key points during hurry, providing more detailed explanations and supplementary information during relaxation, and adding emphasis expressions and color tags during excitement. For example, input “software installation”+emotion “hurry”→output “1. Run the installer. 2. Follow the instructions to install.”; input “software installation”+emotion “relaxation”→output “1. Download the installer. 2. After the download is complete, double-click the executable file. 3. Follow the instructions in the installation wizard and make the necessary settings.”; input “software installation”+emotion “excitement”→output “1. Launch the installer and start your new software experience! (effect tag attached),” etc. The generation unit outputs the results as JSON-format structures (fields: title, description, effect, score, label, etc.), which are used for detail control and layout adjustment in subsequent input and creation units. During training, the generation unit uses a procedure manual dataset with emotion labels (e.g., 10,000 cases, each procedure with length variations for each emotion) as training data, optimizing with a cross-entropy loss function. As a technical effect, the generation unit achieves optimization of length according to user status, improved comprehension, and reduced work stress, which were difficult to realize with conventional uniform procedure manual generation. Application fields include procedure manual generation for field workers in IT equipment deployment sites, manual creation for beginners in educational institutions, and safety management procedure manual creation for medical devices, contributing to improved user experience and work efficiency.

The generation unit can determine the priority of the generated procedure based on the submission timing of the item name during generation. For example, the generation unit determines the priority of the generated procedure based on the submission timing of the item name during generation. The generation unit can use a generative AI to determine the priority of the generated procedure based on the submission timing of the item name. For instance, the generation unit prioritizes procedure generation for item names with imminent submission deadlines. Additionally, the generation unit can postpone procedure generation for item names with distant submission deadlines. Furthermore, the generation unit can dynamically adjust the priority of procedures according to the submission timing. Thus, by determining the priority of procedures based on the submission timing of the item name, efficient procedure creation becomes possible. Specifically, the generation unit utilizes the submission deadline for each item name (e.g., UNIX timestamp or date string), current time, and urgency score (e.g., 0.0-1.0, considering risk of deadline delay and business impact) received from the reception unit or project management system as input data. The generation unit inputs tokenized item names, submission deadline vectors (e.g., remaining days, urgency), project attribute vectors, and past procedure manual data (JSON structures) into a multi-layer transformer-type neural network (12 encoder layers, 12 decoder layers, 6 billion parameters). The generation unit sets higher priority for item names with imminent submission deadlines, dynamically controlling the generation order of output procedure manual fragments and importance labels (e.g., “Urgent,” “Normal,” “Low Priority”). For example, input “network settings”+submission deadline “tomorrow”→priority “Urgent”; input “printer settings”+submission deadline “in two weeks”→priority “Normal,” etc. The generation unit outputs the results as JSON-format structures (fields: title, description, due_date, priority, score, label, etc.), which are used for priority control and scheduling in subsequent input and creation units. During training, the generation unit uses a procedure manual dataset with submission deadline and urgency labels (e.g., 10,000 cases, each procedure with submission timing and priority variations) as training data, optimizing with a cross-entropy loss function. As a technical effect, the generation unit achieves compliance with deadlines, improved business efficiency, and reduced risk of delays, which were difficult to realize with conventional uniform procedure manual generation and manual scheduling. Application fields include procedure manual generation for deadline management in IT equipment deployment sites, semester preparation manual creation for educational institutions, and periodic inspection procedure manual creation for medical devices, contributing to operational efficiency and quality improvement in the field.

The generation unit can adjust the order of generated procedures based on the relevance of item names during generation. For example, the generation unit adjusts the order of generated procedures based on the relevance of item names during generation. The generation unit can use a generative AI to adjust the order of generated procedures based on the relevance of item names. For instance, the generation unit generates procedures preferentially for item names with high relevance. Additionally, the generation unit can generate procedures for item names with low relevance at a later stage. Furthermore, the generation unit can dynamically adjust the order of procedures according to the relevance of item names. By adjusting the order of procedures based on the relevance of item names, efficient procedure creation becomes possible. Specifically, the generation unit utilizes a relevance matrix between item names (e.g., relevance scores for each item name pair ranging from 0.0 to 1.0, frequency of simultaneous execution in the past, dependency graphs, user-specified priorities, etc.) received from the reception unit or a project management system as input data. The generation unit inputs a tokenized list of item names, a relevance matrix (N×N numerical array), a project attribute vector, and past procedure manual data (JSON structure) into a multi-layer transformer-type neural network (12 encoder layers, 12 decoder layers, 6 billion parameters). Based on the relevance scores, the generation unit dynamically controls the generation order and grouping of procedure manual fragments (e.g., network setup→software installation→printer setup), optimizing dependencies and work efficiency. For example, with input “network setup,” “software installation,” “printer setup” and relevance “network setup-software installation: 0.92,” the order would be “network setup→software installation→printer setup.” The generation unit outputs the results as a JSON-structured object (fields: title, description, order, group, score, label, etc.), which is used for subsequent order control and layout adjustment in the input unit and creation unit. During training, the generation unit optimizes using a cross-entropy loss function with a procedure manual dataset labeled with relevance (e.g., 10,000 cases, each procedure with relevance and order variations) as teacher data. As a technical effect, the generation unit achieves work efficiency optimization, dependency management, and error reduction, which were difficult to realize with conventional uniform procedure manual generation or manual order determination. Application fields include generating procedure manuals for multiple coordinated tasks in IT equipment deployment sites, creating composite manuals for educational institutions, and multi-step safety management procedure manuals for medical devices, contributing to operational efficiency and quality improvement in the field.

The input unit can estimate the user's emotion and adjust the input method to the template based on the estimated emotion of the user. For example, the input unit estimates the user's emotion and adjusts the input method to the template based on the estimated emotion. Emotion estimation is realized using an emotion estimation function, for example, by employing an emotion engine or generative AI. The generative AI may be a text generation AI (such as an LLM) or a multimodal generative AI, but is not limited to these examples. For instance, when the user is relaxed, the input unit provides an input method that proceeds at a leisurely pace. When the user is in a hurry, the input unit can provide a concise input method for quick entry. Furthermore, when the user is excited, the input unit can provide an input method with visually stimulating effects. By adjusting the input method according to the user's emotion, a user-friendly input method can be provided. Specifically, the input unit uses emotion labels (e.g., relaxed, hurried, excited) and confidence scores (e.g., 0.85) received from the reception unit or emotion estimation AI as additional context for the input control module. The input unit integrates procedure manual fragments received from the generation unit (in JSON format, fields: title, description, caution, etc.), the user's emotion label (one-hot encoding), and a project attribute vector (e.g., 32-dimensional numerical array) as input to an input algorithm control network (multi-layer perceptron or Transformer-based, 10 million to 100 million parameters). The input unit dynamically changes parameters such as display speed of the input UI, number of input items, presence of supplementary explanations, and effect display flags according to the emotion label. For example, when the emotion is “relaxed,” the input form adds detailed supplementary explanations and help buttons, displaying input items stepwise. When the emotion is “hurried,” only required items are aggregated on a single screen, and input aids such as voice input and auto-completion are emphasized. When the emotion is “excited,” the input form is designed with color highlights and animation effects to attract the user's attention. The input unit assigns importance scores and relevance labels to the input content, which are used for priority control during procedure manual generation by the subsequent creation unit. During training, the input unit optimizes using a cross-entropy loss function with an input history dataset labeled with emotion (e.g., 10,000 cases, each input with emotion state, input time, error rate, etc.) as teacher data. The input unit also controls automatic recovery in case of input errors (e.g., re-entry requests or input hints when invalid data is detected) according to the emotion state, providing concise error explanations under stress and detailed explanations when relaxed. As a technical effect, the input unit achieves dynamic input method optimization according to user state, reduction of input errors and dropout rates, and improvement of user experience, which were difficult to realize with conventional static input UIs or uniform input procedures. Application fields include input support for field workers in IT equipment deployment sites, setup support for beginners in educational institutions, and input of safety management procedures for medical devices, contributing to work efficiency and quality improvement by providing input support responsive to the user's psychological state.

The input unit can adjust the level of detail of input based on the importance of the generated procedure during input. For example, the input unit adjusts the level of detail of input based on the importance of the generated procedure during input. The input unit can use a generative AI to adjust the level of detail of input based on the importance of the generated procedure. For instance, the input unit provides detailed input for procedures with high importance. Additionally, the input unit can provide concise input for procedures with low importance. Furthermore, the input unit can dynamically adjust the level of detail of input according to the importance of the procedure. By adjusting the level of detail of input based on the importance of the generated procedure, appropriate input becomes possible. Specifically, the input unit passes procedure manual fragments received from the generation unit (JSON format, fields: title, description, caution, importance_score, etc.) and importance scores (e.g., 0.0 to 1.0, considering past failure frequency and business impact) to the input control module. The input unit dynamically adjusts the number of input form items, required input fields, presence of supplementary explanations, and strictness of input checks according to the importance score. For example, for a procedure with importance 0.95, the input form adds detailed supplementary explanations and caution input fields, and strengthens consistency checks (e.g., regular expression checks, consistency determination of correlated items). For a procedure with importance 0.40, only the minimum required items are displayed to reduce input burden. The input unit assigns importance scores and relevance labels to the input content, which are used for controlling the level of detail during procedure manual generation by the subsequent creation unit. During training, the input unit optimizes using a cross-entropy loss function with an input history dataset labeled with importance (e.g., 10,000 cases, each input with importance, input time, error rate, etc.) as teacher data. The input unit also controls automatic recovery in case of input errors (e.g., re-entry requests or input hints when invalid data is detected) according to the importance, providing detailed error explanations for high importance and concise explanations for low importance. As a technical effect, the input unit achieves optimization of input detail according to business impact and field requirements, reduction of input errors, and improvement of work efficiency, which were difficult to realize with conventional uniform input forms or static input item designs. Application fields include management of large numbers of procedure manuals in IT equipment deployment sites, creation of standardized procedure manuals in educational institutions, and input of safety management procedures for medical devices, contributing to field adaptability and quality improvement.

The input unit can apply different input algorithms according to the category of the template during input. For example, the input unit applies different input algorithms according to the category of the template during input. The input unit can use a generative AI to apply different input algorithms according to the category of the template. For instance, the input unit applies network-related input algorithms to network setup templates. Additionally, the input unit can apply software-related input algorithms to software installation templates. Furthermore, the input unit can apply hardware-related input algorithms to hardware setup templates. By applying appropriate input algorithms according to the category of the template, highly accurate input becomes possible. Specifically, the input unit controls the input algorithm selection module based on the template category ID (e.g., network, software, hardware, etc., as integer labels or one-hot vectors) received from the generation unit or reception unit. The input unit receives procedure manual fragments (JSON format), category ID, project attribute vector, etc. as input data, and automatically selects optimized input algorithms for each category (e.g., network setup: structured input for IP address/VLAN plus auto-completion; software installation: installer type/OS version selection UI; hardware setup: image upload plus part selection UI). For example, in the network setup category, the input unit adds format checks and auto-suggest functions to the IP address input field; in the software installation category, it implements installer file selection and automatic dependency determination; in the hardware setup category, it inputs wiring photos (128×128 pixel RGB) to an image recognition AI and dynamically generates the necessary part selection UI. The input unit assigns category labels and importance scores to the input content, which are used for controlling the level of detail and layout adjustment during procedure manual generation by the subsequent creation unit. During training, the input unit optimizes using a cross-entropy loss function with a category-specific input history dataset (e.g., 5,000 cases per category, with category-specific input patterns and error rates) as teacher data. As a technical effect, the input unit achieves optimization according to business requirements and field characteristics for each category, high-precision input, and reduction of input errors, which were difficult to realize with conventional uniform input UIs or simple template input. Application fields include input of procedure manuals for diverse categories in IT equipment deployment sites, creation of field-specific manuals in educational institutions, and input of category-specific safety management procedures for medical devices, contributing to field adaptability and quality improvement.

The input unit can estimate the user's emotion and adjust the order of input to the template based on the estimated emotion of the user. For example, the input unit estimates the user's emotion and adjusts the order of input to the template based on the estimated emotion. Emotion estimation is realized using an emotion estimation function, for example, by employing an emotion engine or generative AI. The generative AI may be a text generation AI (such as an LLM) or a multimodal generative AI, but is not limited to these examples. For instance, when the user is in a hurry, the input unit prioritizes input of procedures with high importance. When the user is relaxed, the input unit provides detailed input options and can propose customizable input methods. Furthermore, when the user is excited, the input unit can provide input methods with visually stimulating effects. By adjusting the order of input according to the user's emotion, a user-friendly input method can be provided. Specifically, the input unit passes emotion labels (e.g., hurried, relaxed, excited) and confidence scores (e.g., 0.88) received from the reception unit or emotion estimation AI to the input control module. The input unit inputs a list of procedure manual fragments received from the generation unit (e.g., JSON format, each procedure with importance score and category label) into an order determination algorithm according to the emotion label (e.g., weighted by importance×urgency for hurried, emphasis on customizability for relaxed, effect priority for excited), and dynamically determines the input order. For example, when the emotion is “hurried,” the top three procedures by importance are displayed first; when “relaxed,” detailed options are expanded and a UI allowing the user to freely change the order is provided; when “excited,” procedures with effects are highlighted. The input unit assigns order labels and importance scores to the input content, which are used for order control and layout adjustment during procedure manual generation by the subsequent creation unit. During training, the input unit optimizes using a cross-entropy loss function with an input history dataset labeled with emotion (e.g., 10,000 cases, each input with emotion state, input order, error rate, etc.) as teacher data. As a technical effect, the input unit achieves dynamic optimization of input order according to user state, improved input efficiency, and enhanced user experience, which were difficult to realize with conventional static input order or uniform input procedures. Application fields include input support for field workers in IT equipment deployment sites, setup support for beginners in educational institutions, and input of safety management procedures for medical devices, contributing to work efficiency and quality improvement by controlling input order responsive to the user's psychological state.

The input unit can determine the priority of input based on the submission timing of the generated procedure during input. For example, the input unit determines the priority of input based on the submission timing of the generated procedure during input. The input unit can use a generative AI to determine the priority of input based on the submission timing of the generated procedure. For instance, the input unit prioritizes input for procedures with imminent submission deadlines. Additionally, the input unit can postpone input for procedures with distant submission deadlines. Furthermore, the input unit can dynamically adjust the priority of input according to the submission timing. By determining the priority of input based on the submission timing of the generated procedure, efficient input becomes possible. Specifically, the input unit utilizes submission deadlines for each procedure (e.g., UNIX timestamp or date string), current time, and urgency scores (e.g., 0.0 to 1.0, considering risk of deadline delay and business impact) received from the generation unit or project management system as input data. The input unit inputs a list of procedure manual fragments received from the generation unit (JSON format, each procedure with submission deadline and urgency label) into a priority determination algorithm based on submission deadline and urgency (e.g., order by nearest deadline, weighted by urgency×importance), and dynamically determines the input order and emphasis order in the input UI. For example, a procedure with a deadline “tomorrow” is displayed at the top of the input form, while a procedure with a deadline “two weeks later” is placed at the back. The input unit assigns priority labels and submission deadline scores to the input content, which are used for priority control and scheduling during procedure manual generation by the subsequent creation unit. During training, the input unit optimizes using a cross-entropy loss function with an input history dataset labeled with submission deadline and urgency (e.g., 10,000 cases, each input with submission timing, priority, input time, etc.) as teacher data. As a technical effect, the input unit achieves compliance with deadlines, improved business efficiency, and reduced risk of delays, which were difficult to realize with conventional uniform input order or manual scheduling. Application fields include input of procedure manuals for deadline management in IT equipment deployment sites, creation of semester preparation manuals in educational institutions, and input of periodic inspection procedures for medical devices, contributing to operational efficiency and quality improvement in the field.

The input unit can adjust the order of input based on the relevance of the generated procedure during input. For example, the input unit adjusts the order of input based on the relevance of the generated procedure during input. The input unit can use a generative AI to adjust the order of input based on the relevance of the generated procedure. For instance, the input unit prioritizes input for procedures with high relevance. Additionally, the input unit can postpone input for procedures with low relevance. Furthermore, the input unit can dynamically adjust the order of input according to the relevance of the procedure. By adjusting the order of input based on the relevance of the generated procedure, efficient input becomes possible. Specifically, the input unit utilizes a relevance matrix between procedures (e.g., relevance scores for each procedure pair ranging from 0.0 to 1.0, considering frequency of simultaneous execution in the past and dependency graphs) received from the generation unit or project management system as input data. The input unit inputs a list of procedure manual fragments received from the generation unit (JSON format, each procedure with relevance score and group label) into an order determination algorithm based on relevance (e.g., placing the top relevance group at the beginning, topological sort based on dependency graph), and dynamically determines the input order and grouping in the input UI. For example, if the relevance between “network setup” and “software installation” is 0.92, the input unit recommends inputting software installation after network setup. The input unit assigns order labels and relevance scores to the input content, which are used for order control and layout adjustment during procedure manual generation by the subsequent creation unit. During training, the input unit optimizes using a cross-entropy loss function with an input history dataset labeled with relevance (e.g., 10,000 cases, each input with relevance, order, input time, etc.) as teacher data. As a technical effect, the input unit achieves work efficiency optimization, dependency management, and reduction of input errors, which were difficult to realize with conventional static input order or uniform input procedures. Application fields include input of procedure manuals for multiple coordinated tasks in IT equipment deployment sites, creation of composite manuals in educational institutions, and input of multi-step safety management procedures for medical devices, contributing to operational efficiency and quality improvement in the field.

The creation unit can estimate the user's emotion and adjust the method of creating the procedure manual based on the estimated emotion of the user. For example, the creation unit estimates the user's emotion and adjusts the method of creating the procedure manual based on the estimated emotion. Emotion estimation is realized using an emotion estimation function, for example, by employing an emotion engine or generative AI. The generative AI may be a text generation AI (such as an LLM) or a multimodal generative AI, but is not limited to these examples. For instance, when the user is relaxed, the creation unit creates a procedure manual that proceeds at a leisurely pace. When the user is in a hurry, the creation unit can create a concise procedure manual for quick understanding. Furthermore, when the user is excited, the creation unit can create a procedure manual with visually stimulating effects. By adjusting the method of creating the procedure manual according to the user's emotion, a procedure manual that is easy for the user to understand can be provided. Specifically, the creation unit uses emotion labels (e.g., relaxed, hurried, excited, in one-hot encoding format) and confidence scores (e.g., 0.85) received from the reception unit or emotion estimation AI as additional context for the procedure manual creation control module. The creation unit integrates procedure manual fragments received from the generation unit (JSON format, fields: title, description, caution, effect, etc.), the user's emotion label, and a project attribute vector (e.g., 32-dimensional numerical array) as input to a procedure manual creation algorithm control network (multi-layer perceptron or Transformer-based, 10 million to 100 million parameters). The creation unit dynamically changes parameters such as the structure of the procedure manual (e.g., chapters, number of procedures, presence of supplementary explanations), expression style (e.g., style temperature, level of detail, effect insertion flag), and layout (e.g., font size, color emphasis, insertion of figures and tables) according to the emotion label. For example, when the emotion is “relaxed,” the procedure manual is composed with polite explanations and abundant supplementary information, adding figures and hint sections. When the emotion is “hurried,” the number of procedures is minimized and only key points are emphasized in a concise procedure manual. When the emotion is “excited,” color emphasis and animation effect tags are added within the procedure manual to attract the user's attention. The creation unit outputs the results in formats such as PDF (A4 portrait, font 12 pt, automatic table of contents generation), HTML, and Markdown, and performs layout optimization (adjustment of page breaks, automatic insertion of figures and tables), multilingual support (automatic translation to English, Chinese, etc.), and accessibility support (tagging for voice reading) at output. During training, the creation unit optimizes using a cross-entropy loss function with a procedure manual dataset labeled with emotion (e.g., 10,000 cases, each procedure manual with expression variations by emotion) as teacher data. The creation unit collects feedback on emotion state, work efficiency, and comprehension for the output procedure manual, and utilizes it for retraining and parameter optimization. As a technical effect, the creation unit achieves expression optimization according to user state, improved comprehension, and reduced work stress, which were difficult to realize with conventional uniform procedure manual creation or static template generation. Application fields include generation of procedure manuals for field workers in IT equipment deployment sites, creation of beginner manuals in educational institutions, and creation of safety management procedure manuals for medical devices, contributing to improved user experience and work efficiency.

The creation unit can adjust the level of detail of the procedure manual based on the importance of the generated procedure during creation. For example, the creation unit adjusts the level of detail of the procedure manual based on the importance of the generated procedure during creation. The creation unit can use a generative AI to adjust the level of detail of the procedure manual based on the importance of the generated procedure. For instance, the creation unit creates a detailed procedure manual for procedures with high importance. Additionally, the creation unit can create a concise procedure manual for procedures with low importance. Furthermore, the creation unit can dynamically adjust the level of detail of the procedure manual according to the importance of the procedure. By adjusting the level of detail of the procedure manual based on the importance of the generated procedure, an appropriate procedure manual can be provided. Specifically, the creation unit utilizes importance scores for each procedure (e.g., 0.0 to 1.0, considering past failure frequency, business impact, user-specified priority, etc.) received from the generation unit or project management system as input to the procedure manual creation control module. The creation unit integrates procedure manual fragments received from the generation unit (JSON format, fields: title, description, caution, importance_score, etc.), project attribute vector (e.g., 32-dimensional numerical array), and importance score as input to a procedure manual detail control network (multi-layer perceptron or Transformer-based, 10 million to 100 million parameters). The creation unit dynamically changes parameters such as explanation detail, number of procedures, presence of caution notes, amount of supplementary information, and addition of figures and tables according to the importance score. For example, for a procedure with importance 0.95, the creation unit adds detailed supplementary explanations, caution notes, figures, and hint sections, and describes risks and troubleshooting information for each procedure. For a procedure with importance 0.40, only key points are described concisely, and supplementary explanations and figures are omitted. The creation unit outputs the results in formats such as PDF, HTML, and Markdown, and performs layout optimization (adjustment of page breaks, automatic insertion of figures and tables), multilingual support, and accessibility support at output. During training, the creation unit optimizes using a cross-entropy loss function with a procedure manual dataset labeled with importance (e.g., 10,000 cases, each procedure manual with variations by importance) as teacher data. The creation unit collects feedback on importance, comprehension, and work efficiency for the output procedure manual, and utilizes it for retraining and parameter optimization. As a technical effect, the creation unit achieves optimization of detail according to business impact and field requirements, reduction of work errors, and improved comprehension, which were difficult to realize with conventional uniform procedure manual creation or static template generation. Application fields include generation of procedure manuals for field workers in IT equipment deployment sites, creation of standardized manuals in educational institutions, and creation of safety management procedure manuals for medical devices, contributing to field adaptability and quality improvement.

The creation unit can apply different creation algorithms according to the category of the procedure manual during creation. For example, the creation unit applies different creation algorithms according to the category of the procedure manual during creation. The creation unit can use a generative AI to apply different creation algorithms according to the category of the procedure manual. For instance, the creation unit applies network-related creation algorithms to procedure manuals for network setup. Additionally, the creation unit can apply software-related creation algorithms to procedure manuals for software installation. Furthermore, the creation unit can apply hardware-related creation algorithms to procedure manuals for hardware setup. By applying appropriate creation algorithms according to the category of the procedure manual, highly accurate procedure manuals can be provided. Specifically, the creation unit controls the creation algorithm selection module based on the procedure manual category ID (e.g., network, software, hardware, etc., as integer labels or one-hot vectors) received from the generation unit or reception unit. The creation unit receives procedure manual fragments (JSON format, fields: title, description, category, score, label, etc.), category ID, project attribute vector, etc. as input data, and automatically selects optimized creation algorithms for each category (e.g., network setup: rule-based plus AI hybrid; software installation: template expansion plus AI completion; hardware setup: image recognition AI plus procedure generation AI collaboration). For example, in the network setup category, the creation unit combines rule-based determination of network configuration patterns (e.g., automatic IP address assignment, VLAN setting branching) and natural language generation; in the software installation category, it expands templates considering installer type, OS version, and dependencies plus AI completion; in the hardware setup category, it analyzes image input (e.g., wiring photo 128×128 pixel RGB) with a CNN and inputs necessary procedures to the generation AI, implementing different processing flows for each category. The creation unit outputs category-optimized procedure manuals (PDF, HTML, Markdown, etc.) and performs layout optimization, multilingual support, and accessibility support at output. During training, the creation unit optimizes using a cross-entropy loss function with a category-specific procedure manual dataset (e.g., 10,000 cases per category, with category-specific rules and expression variations) as teacher data. As a technical effect, the creation unit achieves optimization according to business requirements and field characteristics for each category, high-precision procedure manual generation, and reduction of work errors, which were difficult to realize with conventional uniform procedure manual creation or simple template generation. Application fields include generation of procedure manuals for diverse categories in IT equipment deployment sites, creation of field-specific manuals in educational institutions, and creation of category-specific safety management procedure manuals for medical devices, contributing to field adaptability and quality improvement.

The creation unit can estimate the user's emotion and adjust the display method of the procedure manual based on the estimated emotion of the user. For example, the creation unit estimates the user's emotion and adjusts the display method of the procedure manual based on the estimated emotion. Emotion estimation is realized using an emotion estimation function, for example, by employing an emotion engine or generative AI. The generative AI may be a text generation AI (such as an LLM) or a multimodal generative AI, but is not limited to these examples. For instance, when the user is nervous, the creation unit provides a simple and highly visible display method. When the user is relaxed, the creation unit can provide a display method including detailed information. Furthermore, when the user is in a hurry, the creation unit can provide a display method that emphasizes key points. By adjusting the display method of the procedure manual according to the user's emotion, a procedure manual that is easy for the user to view can be provided. Specifically, the creation unit uses emotion labels (e.g., nervous, relaxed, hurried, in one-hot encoding format) and confidence scores (e.g., 0.87) received from the reception unit or emotion estimation AI as additional context for the procedure manual display control module. The creation unit integrates procedure manual fragments received from the generation unit (JSON format, fields: title, description, caution, effect, etc.), the user's emotion label, and project attribute vector as input to a display algorithm control network (multi-layer perceptron or Transformer-based, 10 million to 100 million parameters). The creation unit dynamically changes parameters such as layout (e.g., font size, color emphasis, insertion of figures and tables), number of display items, presence of supplementary explanations, and effect display flags according to the emotion label. For example, when the emotion is “nervous,” the procedure manual is displayed with a simple layout, large font, and minimal information; when “relaxed,” detailed supplementary explanations and figures are displayed abundantly; when “hurried,” the layout emphasizes only key points. The creation unit outputs the results in formats such as PDF, HTML, and Markdown, and implements responsive design and accessibility support (tagging for voice reading, color vision barrier-free coloring) at output. During training, the creation unit optimizes using a cross-entropy loss function with a procedure manual display dataset labeled with emotion (e.g., 10,000 cases, each display with layout variations by emotion) as teacher data. As a technical effect, the creation unit achieves display optimization according to user state, improved visibility, and improved comprehension, which were difficult to realize with conventional uniform procedure manual display or static layout design. Application fields include display of procedure manuals for field workers in IT equipment deployment sites, display of beginner manuals in educational institutions, and display of safety management procedure manuals for medical devices, contributing to improved user experience and work efficiency.

The creation unit can determine the priority of the procedure manual based on the submission timing of the generated procedure during creation. For example, the creation unit determines the priority of the procedure manual based on the submission timing of the generated procedure during creation. The creation unit can use a generative AI to determine the priority of the procedure manual based on the submission timing of the generated procedure. For instance, the creation unit prioritizes creation of procedure manuals for procedures with imminent submission deadlines. Additionally, the creation unit can postpone creation of procedure manuals for procedures with distant submission deadlines. Furthermore, the creation unit can dynamically adjust the priority of the procedure manual according to the submission timing. By determining the priority of the procedure manual based on the submission timing of the generated procedure, efficient procedure manual creation becomes possible. Specifically, the creation unit utilizes submission deadlines for each procedure (e.g., UNIX timestamp or date string), current time, and urgency scores (e.g., 0.0 to 1.0, considering risk of deadline delay and business impact) received from the generation unit or project management system as input to the procedure manual creation control module. The creation unit integrates a list of procedure manual fragments received from the generation unit (JSON format, each procedure with submission deadline and urgency label), project attribute vector, etc. as input to a priority determination algorithm (e.g., order by nearest deadline, weighted by urgency×importance), and dynamically determines the creation order of procedure manuals and emphasis order in the output UI. For example, a procedure with a deadline “tomorrow” is placed at the beginning of the procedure manual, while a procedure with a deadline “two weeks later” is placed at the end. The creation unit outputs the results in formats such as PDF, HTML, and Markdown, and assigns priority labels and submission deadline scores at output, recording them in the history management system. During training, the creation unit optimizes using a cross-entropy loss function with a procedure manual dataset labeled with submission deadline and urgency (e.g., 10,000 cases, each procedure manual with submission timing, priority, creation time, etc.) as teacher data. As a technical effect, the creation unit achieves compliance with deadlines, improved business efficiency, and reduced risk of delays, which were difficult to realize with conventional uniform procedure manual creation order or manual scheduling. Application fields include creation of procedure manuals for deadline management in IT equipment deployment sites, creation of semester preparation manuals in educational institutions, and creation of periodic inspection procedure manuals for medical devices, contributing to operational efficiency and quality improvement in the field.

The creation unit can adjust the order of the procedure manual based on the relevance of the generated procedure during creation. For example, the creation unit adjusts the order of the procedure manual based on the relevance of the generated procedure during creation. The creation unit can use a generative AI to adjust the order of the procedure manual based on the relevance of the generated procedure. For instance, the creation unit prioritizes creation of procedure manuals for procedures with high relevance. Additionally, the creation unit can postpone creation of procedure manuals for procedures with low relevance. Furthermore, the creation unit can dynamically adjust the order of the procedure manual according to the relevance of the procedure. By adjusting the order of the procedure manual based on the relevance of the generated procedure, efficient procedure manual creation becomes possible. Specifically, the creation unit utilizes a relevance matrix between procedures (e.g., relevance scores for each procedure pair ranging from 0.0 to 1.0, considering frequency of simultaneous execution in the past and dependency graphs) received from the generation unit or project management system as input to the procedure manual creation control module. The creation unit integrates a list of procedure manual fragments received from the generation unit (JSON format, each procedure with relevance score and group label), project attribute vector, etc. as input to an order determination algorithm based on relevance (e.g., placing the top relevance group at the beginning, topological sort based on dependency graph), and dynamically determines chapter structure, procedure order, and grouping of the procedure manual. For example, if the relevance between “network setup” and “software installation” is 0.92, the software installation chapter is placed immediately after the network setup chapter. The creation unit outputs the results in formats such as PDF, HTML, and Markdown, and assigns order labels and relevance scores at output, recording them in the history management system. During training, the creation unit optimizes using a cross-entropy loss function with a procedure manual dataset labeled with relevance (e.g., 10,000 cases, each procedure manual with relevance, order, creation time, etc.) as teacher data. As a technical effect, the creation unit achieves work efficiency optimization, dependency management, and error reduction, which were difficult to realize with conventional static procedure manual order or uniform chapter structure design. Application fields include creation of procedure manuals for multiple coordinated tasks in IT equipment deployment sites, creation of composite manuals in educational institutions, and creation of multi-step safety management procedure manuals for medical devices, contributing to operational efficiency and quality improvement in the field.

The system according to the embodiment is not limited to the examples described above and can be variously modified as follows. Specifically, the system has a flexible design philosophy that allows for a wide variety of variations, including the architecture of the AI model and data flow, the cooperation method of various modules, the types of input data and output formats, the design of the user interface, the composition of the training dataset, parameter optimization methods, hardware configuration (e.g., GPU clusters, distributed storage), and operational environments (on-premises, cloud, edge devices, etc.). For example, the system can select the optimal AI configuration according to the purpose and field requirements, such as using a Transformer-based large language model as the emotion estimation AI, adopting a multimodal neural network that integrates voice, image, and operation logs, or using a time-series LSTM network or graph neural network as the history analysis AI. The system can combine multiple types of data as input, such as voice data (16 kHz 16 bit PCM), text strings (UTF-8 up to 512 characters), image data (128×128 pixel RGB), operation logs (time-series vectors), location information vectors (latitude, longitude, area code, etc.), and social media post data (text, category ID, post frequency vector). As output data, the system generates procedure manual fragments (JSON format, fields: title, description, caution, effect, score, label, etc.), candidate item name lists (with relevance scores), input UI control parameters (display order, level of detail, effect flags, etc.), and metadata for history management (version, creation date, user ID, etc.), which can be used for subsequent processing and integration with other systems. The system can combine supervised learning (cross-entropy loss function), transfer learning, data augmentation (noise addition, paraphrase generation), and online retraining using user feedback as training methods for the AI model. As post-processing of AI inference results, the system can implement threshold judgment (e.g., automatic adoption only for confidence above 0.8), branching processing (UI control according to emotion state or importance), recording in the history management system, and external system integration via API (asset management, help desk, etc.). Furthermore, the system can select the output format of the procedure manual from PDF, HTML, Markdown, JSON, XML, etc., and easily realize function extensions such as layout optimization (adjustment of page break positions, automatic insertion of figures and tables), multilingual support (automatic translation), and accessibility support (tagging for voice reading, color vision barrier-free coloring). As a technical effect, the system achieves dynamic procedure manual generation, input support, display control, and history management responsive to field requirements and user state, which were difficult to realize with conventional static template design or manual rule description, resulting in significant improvement in work efficiency, elimination of human error, quality standardization, and enhancement of field adaptability. Application fields include multi-site deployment in IT equipment introduction, large-scale SI projects, creation of standardized manuals in educational institutions, creation of facility-specific safety management procedure manuals for medical devices, and mobile manual distribution for field workers, all of which greatly contribute to work efficiency and quality improvement in these fields.

The reception unit can analyze the user's past input history and select an appropriate input method. For example, the reception unit automatically displays frequently entered kitting item names by the user as candidates. Additionally, the reception unit can preferentially propose input methods (such as voice or text) previously used by the user. Furthermore, the reception unit can predict and propose kitting item names used at specific times based on the user's past input history. By analyzing past input history, the optimal input method can be provided. Specifically, the reception unit maintains an input history database for each user (e.g., a structure recording each input time, input method, item name, input duration, and input success/failure), and inputs history data (e.g., the most recent 100 input sequences, each sequence as a vector of input method ID, item name ID, time, success/failure flag, etc.) into an analysis AI (e.g., time-series LSTM network, 1 million parameters). The analysis AI extracts frequently used item names (e.g., entered more than five times in the past week), trends in input methods (e.g., 70% voice input, 30% text input), and usage patterns by time of day (e.g., “network setup” in the morning, “software installation” in the afternoon), and outputs recommended input methods (e.g., voice, text, template selection, etc.) and candidate item name lists (e.g., top three by frequency). For example, user A's history: “network setup entered five times by voice input, printer setup entered twice by text input”→recommendation: “voice input+network setup”; user B's history: “software installation entered three times in the afternoon”→recommendation: “display software installation as a candidate in the afternoon,” and so on. Based on the output of the analysis AI, the reception unit inputs to the UI control module, automatically selects the recommended input method as default, displays candidate item names as suggestions, and switches candidates according to the time of day. During training, the analysis AI is optimized using a cross-entropy loss function or time-series prediction error function, with history data and actual selection results as teacher data. As a technical effect, the reception unit achieves input support optimized for each user's usage trends, improved input efficiency, and reduced input errors and rework, which were difficult to realize with conventional static candidate display or uniform input method presentation. Application fields include input support for field workers in IT equipment deployment sites, creation of standardized procedure manuals in educational institutions, and input of safety management procedures for medical devices, contributing to improved user experience and work efficiency.

The generation unit can adjust the level of detail of generated procedures based on the importance of item names during generation. For example, the generation unit generates detailed procedures for item names with high importance. Additionally, the generation unit can generate concise procedures for item names with low importance. Furthermore, the generation unit can dynamically adjust the level of detail of procedures according to the importance of item names. By adjusting the level of detail of procedures based on the importance of item names, appropriate procedures can be provided. Specifically, the generation unit utilizes importance scores for each item name (e.g., 0.0 to 1.0, considering past failure frequency, business impact, user-specified priority, etc.) received from the reception unit or project management system as additional input to the generative AI. The generation unit inputs tokenized item names, project attribute vectors, importance scores (continuous values or category labels), and past procedure manual data (JSON structure) into a multi-layer transformer-type neural network (12 encoder layers, 12 decoder layers, 6 billion parameters). The generation unit dynamically changes decoder output control parameters (e.g., explanation detail, number of procedures, presence of caution notes, etc.) according to the importance score, generating detailed explanations, supplementary information, and caution notes for high importance, and concise procedures focusing only on key points for low importance. For example, input “network setup”+importance 0.95→output “1. Open the control panel. 2. Select network and internet. 3. Change adapter settings. 4. Check security settings. 5. Recommend reboot after setting.”; input “printer setup”+importance 0.40→output “1. Connect the printer. 2. Install the driver.” The generation unit outputs the results as a JSON-structured object (fields: title, description, caution, score, label, etc.), which is used for subsequent detail control and layout adjustment in the input unit and creation unit. During training, the generation unit optimizes using a cross-entropy loss function with a procedure manual dataset labeled with importance (e.g., 10,000 cases, each procedure with variations by importance) as teacher data. As a technical effect, the generation unit achieves optimization of detail according to business impact and field requirements, reduction of work errors, and improved comprehension, which were difficult to realize with conventional uniform procedure manual generation. Application fields include generation of procedure manuals for field workers in IT equipment deployment sites, creation of standardized manuals in educational institutions, and creation of safety management procedure manuals for medical devices, contributing to field adaptability and quality improvement.

The creation unit can estimate the user's emotion and adjust the display method of the procedure manual based on the estimated emotion of the user. For example, when the user is nervous, the creation unit provides a simple and highly visible display method. When the user is relaxed, the creation unit can provide a display method including detailed information. Furthermore, when the user is in a hurry, the creation unit can provide a display method that emphasizes key points. By adjusting the display method of the procedure manual according to the user's emotion, a procedure manual that is easy for the user to view can be provided. Specifically, the creation unit uses emotion labels (e.g., nervous, relaxed, hurried, in one-hot encoding format) and confidence scores (e.g., 0.87) received from the reception unit or emotion estimation AI as additional context for the procedure manual display control module. The creation unit integrates procedure manual fragments received from the generation unit (JSON format, fields: title, description, caution, effect, etc.), the user's emotion label, and project attribute vector as input to a display algorithm control network (multi-layer perceptron or Transformer-based, 10 million to 100 million parameters). The creation unit dynamically changes parameters such as layout (e.g., font size, color emphasis, insertion of figures and tables), number of display items, presence of supplementary explanations, and effect display flags according to the emotion label. For example, when the emotion is “nervous,” the procedure manual is displayed with a simple layout, large font, and minimal information; when “relaxed,” detailed supplementary explanations and figures are displayed abundantly; when “hurried,” the layout emphasizes only key points. The creation unit outputs the results in formats such as PDF, HTML, and Markdown, and implements responsive design and accessibility support (tagging for voice reading, color vision barrier-free coloring) at output. During training, the creation unit optimizes using a cross-entropy loss function with a procedure manual display dataset labeled with emotion (e.g., 10,000 cases, each display with layout variations by emotion) as teacher data. As a technical effect, the creation unit achieves display optimization according to user state, improved visibility, and improved comprehension, which were difficult to realize with conventional uniform procedure manual display or static layout design. Application fields include display of procedure manuals for field workers in IT equipment deployment sites, display of beginner manuals in educational institutions, and display of safety management procedure manuals for medical devices, contributing to improved user experience and work efficiency.

The input unit can adjust the level of detail of input based on the importance of the generated procedure during input. For example, the input unit provides detailed input for procedures with high importance. Additionally, the input unit can provide concise input for procedures with low importance. Furthermore, the input unit can dynamically adjust the level of detail of input according to the importance of the procedure. By adjusting the level of detail of input based on the importance of the generated procedure, appropriate input becomes possible. Specifically, the input unit passes procedure manual fragments received from the generation unit (JSON format, fields: title, description, caution, importance_score, etc.) and importance scores (e.g., 0.0 to 1.0, considering past failure frequency and business impact) to the input control module. The input unit dynamically adjusts the number of input form items, required input fields, presence of supplementary explanations, and strictness of input checks according to the importance score. For example, for a procedure with importance 0.95, the input form adds detailed supplementary explanations and caution input fields, and strengthens consistency checks (e.g., regular expression checks, consistency determination of correlated items). For a procedure with importance 0.40, only the minimum required items are displayed to reduce input burden. The input unit assigns importance scores and relevance labels to the input content, which are used for controlling the level of detail during procedure manual generation by the subsequent creation unit. During training, the input unit optimizes using a cross-entropy loss function with an input history dataset labeled with importance (e.g., 10,000 cases, each input with importance, input time, error rate, etc.) as teacher data. The input unit also controls automatic recovery in case of input errors (e.g., re-entry requests or input hints when invalid data is detected) according to the importance, providing detailed error explanations for high importance and concise explanations for low importance. As a technical effect, the input unit achieves optimization of input detail according to business impact and field requirements, reduction of input errors, and improvement of work efficiency, which were difficult to realize with conventional uniform input forms or static input item designs. Application fields include management of large numbers of procedure manuals in IT equipment deployment sites, creation of standardized procedure manuals in educational institutions, and input of safety management procedures for medical devices, contributing to field adaptability and quality improvement.

The reception unit can estimate a user's emotion and adjust the timing of inputting the kitting item name based on the estimated emotion of the user. For example, when the user is feeling stressed, the reception unit provides a simple interface and minimizes the input steps. When the user is relaxed, the reception unit can provide detailed input options and propose customizable input methods. Furthermore, when the user is in a hurry, the reception unit can prioritize voice input to enable rapid entry of kitting item names. By adjusting the timing of input according to the user's emotion, the user's burden can be reduced. Specifically, the reception unit receives user input data (e.g., voice data 16 kHz 16 bit PCM, text string UTF-8 up to 256 characters, facial image 128×128 pixel RGB, mouse/touch operation logs, etc.) and inputs it into an emotion estimation AI (e.g., multimodal neural network, Transformer-based integrating voice, text, and image features, 500 million parameters). The emotion estimation AI extracts features such as voice pitch, speed, intonation, positive/negative vocabulary in text, facial feature points, and operation speed from the input data, and outputs emotion labels (e.g., stress, relaxation, excitement, impatience) and confidence scores (e.g., 0.85). For example, voice input “I want to finish quickly” plus facial image (frown)→output “stress”+0.92; text input “I want to proceed slowly” plus operation log (low speed)→output “relaxation”+0.88, and so on. Based on the output of the emotion estimation AI, the reception unit inputs to the UI display control module, dynamically adjusting input timing, steps, and UI configuration, such as minimizing the number of input items under stress, emphasizing the voice input button when in a hurry, and expanding detailed options when relaxed. During training, the emotion estimation AI is optimized using a teacher dataset combining voice, text, image, and operation logs (e.g., 10,000 cases, each data labeled with emotion) and a cross-entropy loss function. As a technical effect, the reception unit achieves dynamic input timing control according to user state, reduction of user burden, and reduction of input errors and dropout rates, which were difficult to realize with conventional static UIs or uniform input procedures. Application fields include input support for field workers in IT equipment deployment sites, setup support for beginners in educational institutions, and input of safety management procedures for medical devices, contributing to improved user experience and work efficiency.

The generation unit can apply different generation algorithms according to the category of item names during generation. For example, the generation unit applies network-related generation algorithms to item names for network setup. Additionally, the generation unit can apply software-related generation algorithms to item names for software installation. Furthermore, the generation unit can apply hardware-related generation algorithms to item names for hardware setup. By applying appropriate generation algorithms according to the category of item names, highly accurate procedures can be provided. Specifically, the generation unit controls the algorithm selection module of the generative AI based on the category ID for each item name (e.g., network, software, hardware, etc., as integer labels or one-hot vectors) received from the reception unit. The generation unit receives tokenized item names, category ID, project attribute vector, and past procedure manual data (category-specific subset) as input, and automatically selects optimized generation algorithms for each category (e.g., network setup: rule-based plus Transformer hybrid; software installation: procedure template plus large language model; hardware setup: image recognition AI plus procedure generation AI collaboration). For example, in the network setup category, the generation unit combines rule-based determination of network configuration patterns (e.g., automatic IP address assignment, VLAN setting branching) and natural language generation; in the software installation category, it expands templates considering installer type, OS version, and dependencies plus AI completion; in the hardware setup category, it analyzes image input (e.g., wiring photo 128×128 pixel RGB) with a CNN and inputs necessary procedures to the generation AI, implementing different processing flows for each category. The generation unit outputs category-optimized procedure manual fragments (JSON format, fields: title, description, category, score, label, etc.), which are used for subsequent detail control and layout adjustment in the input unit and creation unit. During training, the generation unit optimizes using a cross-entropy loss function with a category-specific procedure manual dataset (e.g., 10,000 cases per category, with category-specific rules and expression variations) as teacher data. As a technical effect, the generation unit achieves optimization according to business requirements and field characteristics for each category, high-precision procedure generation, and reduction of work errors, which were difficult to realize with conventional uniform procedure manual generation or simple template matching. Application fields include generation of procedure manuals for diverse categories in IT equipment deployment sites, creation of field-specific manuals in educational institutions, and creation of category-specific safety management procedure manuals for medical devices, contributing to field adaptability and quality improvement.

The creation unit can estimate a user's emotion and adjust the method of creating the procedure manual based on the estimated emotion of the user. For example, when the user is relaxed, the creation unit creates a procedure manual that progresses at a leisurely pace. When the user is in a hurry, the creation unit can also create a concise procedure manual that enables quick understanding. Furthermore, when the user is excited, the creation unit can create a procedure manual with visually stimulating effects. By adjusting the method of creating the procedure manual according to the user's emotion, a procedure manual that is easy for the user to understand can be provided. Specifically, the creation unit utilizes emotion labels (e.g., relaxed, hurried, excited, etc., in one-hot encoding format) and confidence scores (e.g., 0.85) received from the reception unit or emotion estimation AI as additional context for the procedure manual creation control module. The creation unit integrates input data such as procedure manual fragments received from the generation unit (in JSON format, fields: title, description, caution, effect, etc.), user emotion labels, and project attribute vectors (e.g., 32-dimensional numerical arrays), and inputs them into a procedure manual creation algorithm control network (multi-layer perceptron or Transformer-based, with 10 million to 100 million parameters). The creation unit dynamically changes parameters such as the structure of the procedure manual (e.g., chapter organization, number of steps, presence or absence of supplementary explanations), expression style (e.g., style temperature, level of detail in explanations, effect insertion flags), and layout (e.g., font size, color emphasis, insertion of figures and tables) according to the emotion label. For example, when the emotion is “relaxed,” the procedure manual is composed with polite explanations and abundant supplementary information, and figures and hint sections are added. When the emotion is “hurried,” the number of steps is minimized and only the key points are emphasized to generate a concise procedure manual. When the emotion is “excited,” color emphasis and animation effect tags are added within the procedure manual to attract the user's attention. The creation unit outputs the results in formats such as PDF (A4 portrait, 12 pt font, automatic table of contents generation), HTML, and Markdown, and performs layout optimization (adjustment of page breaks, automatic insertion of figures and tables), multilingual support (automatic translation into English, Chinese, etc.), and accessibility support (tagging for voice reading) at the time of output. During training, the creation unit optimizes using a procedure manual dataset with emotion labels (e.g., 10,000 cases, each procedure manual with emotion-specific expression variations) as teacher data and a cross-entropy loss function. The creation unit collects feedback on the output procedure manual regarding emotional state, work efficiency, and comprehension, and utilizes it for retraining and parameter optimization. As a technical effect, the creation unit achieves expression optimization according to user state, improved comprehension, and reduced work stress, which were difficult to realize with conventional uniform procedure manual creation or static template generation. Application fields include generation of procedure manuals for on-site workers during IT equipment installation, creation of beginner manuals for educational institutions, and creation of safety management procedure manuals for medical devices, contributing to improved user experience and work efficiency.

The input unit can apply different input algorithms according to the category of the template at the time of input. For example, the input unit applies network-related input algorithms to network configuration templates. The input unit can also apply software-related input algorithms to software installation templates. Furthermore, the input unit can apply hardware-related input algorithms to hardware configuration templates. By applying appropriate input algorithms according to the category of the template, highly accurate input becomes possible. Specifically, the input unit controls the input algorithm selection module based on the template category ID (e.g., network, software, hardware, etc., as integer labels or one-hot vectors) received from the generation unit or reception unit. The input unit receives input data such as procedure manual fragments (in JSON format), category ID, and project attribute vectors, and automatically selects the input algorithm optimized for each category (e.g., for network configuration: structured input for IP addresses and VLANs plus auto-completion; for software installation: installer type and OS version selection UI; for hardware configuration: image upload plus component selection UI). For example, in the network configuration category, format checking and auto-suggestion functions are provided for the IP address input field; in the software installation category, installer file selection and automatic dependency determination functions are implemented; in the hardware configuration category, wiring photos (128×128 pixel RGB) are input to an image recognition AI, and the necessary component selection UI is dynamically generated. The input unit attaches category labels and importance scores to the input content and utilizes them for controlling the level of detail and layout adjustment during procedure manual generation by the subsequent creation unit. During training, the input unit optimizes using a category-specific input history dataset (e.g., 5,000 cases per category, with category-specific input patterns and error occurrence rates) as teacher data and a cross-entropy loss function. As a technical effect, the input unit achieves optimization according to business requirements and on-site characteristics for each category, high-precision input, and reduction of input errors, which were difficult to realize with conventional uniform input UIs or simple template input. Application fields include input of procedure manuals for various categories in IT equipment installation sites, creation of field-specific manuals for educational institutions, and input of category-specific safety management procedures for medical devices, contributing to improved on-site adaptability and quality.

The generation unit can estimate a user's emotion and adjust the length of the generated procedure according to the estimated emotion of the user. For example, when the user is in a hurry, the generation unit generates short procedures that focus on the key points. When the user is relaxed, the generation unit can also generate longer procedures with detailed explanations. Furthermore, when the user is excited, the generation unit can generate procedures with visually stimulating effects. By adjusting the length of the procedure according to the user's emotion, appropriate procedures can be provided to the user. Specifically, the generation unit inputs emotion labels (e.g., hurried, relaxed, excited, etc.) and confidence scores (e.g., 0.88) received from the reception unit as additional context to the generative AI. The generation unit inputs tokenized item names, project attribute vectors, user emotion labels (one-hot encoding), and past procedure manual data (JSON structure) into a multi-layer transformer neural network (12 encoder layers, 12 decoder layers, 6 billion parameters). The generation unit dynamically changes decoder output control parameters (e.g., maximum number of steps, level of detail in explanations, presence or absence of effect insertion) according to the emotion label, minimizing the number of steps and emphasizing key points when hurried, providing detailed explanations and supplementary information when relaxed, and adding emphasis expressions and color tags when excited, thereby adjusting the length and expression of procedure manual fragments. For example, input “software installation”+emotion “hurried”→output “1. Run the installer. 2. Follow the instructions to install.”; input “software installation”+emotion “relaxed”→output “1. Download the installer. 2. Once the download is complete, double-click the executable file. 3. Follow the instructions in the installation wizard and make the necessary settings.”; input “software installation”+emotion “excited”→output “1. Launch the installer and start your new software experience! (with effect tag)”. The generation unit outputs the results as JSON format structures (fields: title, description, effect, score, label, etc.), which are used for controlling the level of detail and layout adjustment in the subsequent input unit and creation unit. During training, the generation unit optimizes using a procedure manual dataset with emotion labels (e.g., 10,000 cases, each procedure with emotion-specific length variations) as teacher data and a cross-entropy loss function. As a technical effect, the generation unit achieves length optimization according to user state, improved comprehension, and reduced work stress, which were difficult to realize with conventional uniform procedure manual generation. Application fields include generation of procedure manuals for on-site workers during IT equipment installation, creation of beginner manuals for educational institutions, and creation of safety management procedure manuals for medical devices, contributing to improved user experience and work efficiency.

The creation unit can determine the priority of procedure manuals based on the submission timing of the generated procedures at the time of creation. For example, the creation unit creates procedure manuals with higher priority for procedures with imminent submission deadlines. The creation unit can also create procedure manuals for procedures with distant submission deadlines at a later time. Furthermore, the creation unit can dynamically adjust the priority of procedure manuals according to the submission timing. By determining the priority of procedure manuals based on the submission timing of the generated procedures, efficient procedure manual creation becomes possible. Specifically, the creation unit utilizes the submission deadlines of each procedure (e.g., UNIX timestamp or date string), current time, and urgency scores (e.g., 0.0 to 1.0, considering risk of deadline delay and business impact) received from the generation unit or project management system as input to the procedure manual creation control module. The creation unit integrates input data such as lists of procedure manual fragments received from the generation unit (in JSON format, each procedure with submission deadline and urgency label), project attribute vectors, etc., and inputs them into a priority determination algorithm (e.g., order by nearest submission deadline, weighted by urgency×importance), dynamically determining the order of procedure manual creation and the order of emphasis in the output UI. For example, procedures with a submission deadline of “tomorrow” are placed at the beginning of the procedure manual, while procedures with a submission deadline of “two weeks later” are placed at the end. The creation unit outputs the results in formats such as PDF, HTML, and Markdown, attaching priority labels and submission deadline scores at the time of output, and records them in the history management system. During training, the creation unit optimizes using a procedure manual dataset with submission deadline and urgency labels (e.g., 10,000 cases, each procedure manual with submission timing, priority, and required creation time) as teacher data and a cross-entropy loss function. As a technical effect, the creation unit achieves compliance with deadlines, improved business efficiency, and reduced risk of delay, which were difficult to realize with conventional uniform procedure manual creation order or manual scheduling. Application fields include creation of procedure manuals for deadline management in IT equipment installation sites, preparation manuals for the start of academic terms in educational institutions, and creation of periodic inspection procedure manuals for medical devices, contributing to improved operational efficiency and quality in the field.

Below, the flow of processing in Example of the Embodiment is briefly described. Specifically, the present system operates in cooperation among the modules of the reception unit, generation unit, input unit, and creation unit, and sequentially executes inference, generation, input assistance, and procedure manual creation by the AI model. The reception unit receives input data from the user (e.g., kitting item name, audio data, text string, image, operation log, etc.), and, as necessary, inputs it to the emotion estimation AI or history analysis AI to generate emotion labels, recommended input methods, candidate item name lists, etc. The generation unit inputs item names, emotion labels, project attribute vectors, importance scores, etc. received from the reception unit into a multi-layer transformer neural network to generate procedure manual fragments (in JSON format, fields: title, description, caution, effect, score, label, etc.). The input unit dynamically controls the number of items, order, supplementary explanations, effect display, etc. of the input form based on the procedure manual fragments and input control parameters received from the generation unit, assisting the user to input efficiently and without errors. The creation unit integrates master data and lists of procedure manual fragments, emotion labels, project attribute vectors, etc. received from the input unit, inputs them into the procedure manual creation algorithm control network, and automatically generates the final procedure manual in formats such as PDF, HTML, and Markdown. Each module utilizes AI model inference results, cooperation with the history management system, and retraining triggers based on user feedback to realize dynamic procedure manual generation, input assistance, and display control that respond immediately to on-site requirements and user state. As a technical effect, the present system achieves on-site adaptability, work efficiency, quality standardization, and elimination of human error, which were difficult to realize with conventional static template design or manual rule description. Application fields include multi-site deployment in IT equipment installation sites, large-scale SI projects, creation of standardized manuals for educational institutions, and creation of facility-specific safety management procedure manuals for medical devices, greatly contributing to work efficiency and quality improvement in these fields.

Step 1: The reception unit inputs the kitting item name. For example, item names such as “network configuration” or “software installation” can be input. Step 2: The generation unit uses a generative AI to generate a response based on the item name input by the reception unit. For example, the generation unit inputs the item name “network configuration” into the generative AI, and the generative AI generates specific setting procedures. The generation unit generates a response based on the algorithm or training data of the generative AI. For example, the generation unit uses neural networks or transformer models of the generative AI, learns from past procedure manual data and user feedback data, and generates responses. Step 3: The input unit inputs the response generated by the generation unit into the master template. For example, the generated response is input into a master template in the form of an Excel sheet or database. Step 4: The creation unit automatically creates a kitting procedure manual based on the master input by the input unit. For example, by inputting the kitting item name, the creation unit automatically creates a procedure manual based on the created master. The creation unit provides the generated procedure manual to the user. For example, the generated procedure manual is output in PDF format and provided to the user. Specifically, in Step 1, the reception unit receives input data from the user (e.g., audio data 16 kHz 16 bit PCM, text string UTF-8 up to 256 characters, facial image 128×128 pixel RGB, operation log, etc.), inputs it to the emotion estimation AI or history analysis AI, and generates emotion labels, recommended input methods, candidate item name lists, etc. In Step 2, the generation unit inputs item names, emotion labels, project attribute vectors, importance scores, etc. received from the reception unit into a multi-layer transformer neural network to generate procedure manual fragments (in JSON format, fields: title, description, caution, effect, score, label, etc.). In Step 3, the input unit dynamically controls the number of items, order, supplementary explanations, effect display, etc. of the input form based on the procedure manual fragments and input control parameters received from the generation unit, assisting the user to input efficiently and without errors. In Step 4, the creation unit integrates master data and lists of procedure manual fragments, emotion labels, project attribute vectors, etc. received from the input unit, inputs them into the procedure manual creation algorithm control network, and automatically generates the final procedure manual in formats such as PDF, HTML, and Markdown. Each step utilizes AI model inference results, cooperation with the history management system, and retraining triggers based on user feedback to realize dynamic procedure manual generation, input assistance, and display control that respond immediately to on-site requirements and user state. As a technical effect, the present system achieves on-site adaptability, work efficiency, quality standardization, and elimination of human error, which were difficult to realize with conventional static template design or manual rule description. Application fields include multi-site deployment in IT equipment installation sites, large-scale SI projects, creation of standardized manuals for educational institutions, and creation of facility-specific safety management procedure manuals for medical devices, greatly contributing to work efficiency and quality improvement in these fields.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned reception unit, generation unit, input unit, and creation unit is implemented by at least one of, for example, a smart device 14 and a data processing apparatus 12. For example, the reception unit is implemented by a control unit 46A of the smart device 14 and inputs a kitting item name. The generation unit is implemented, for example, by a specific processing unit 290 of the data processing apparatus 12 and generates a response using a generative AI. The input unit is implemented, for example, by the control unit 46A of the smart device 14 and inputs the generated response into a master template. The creation unit is implemented, for example, by the specific processing unit 290 of the data processing apparatus 12 and automatically creates a kitting procedure manual based on the input master. The correspondence between each unit and the apparatus or control unit is not limited to the examples described above and various modifications are possible.

### Second Embodiment

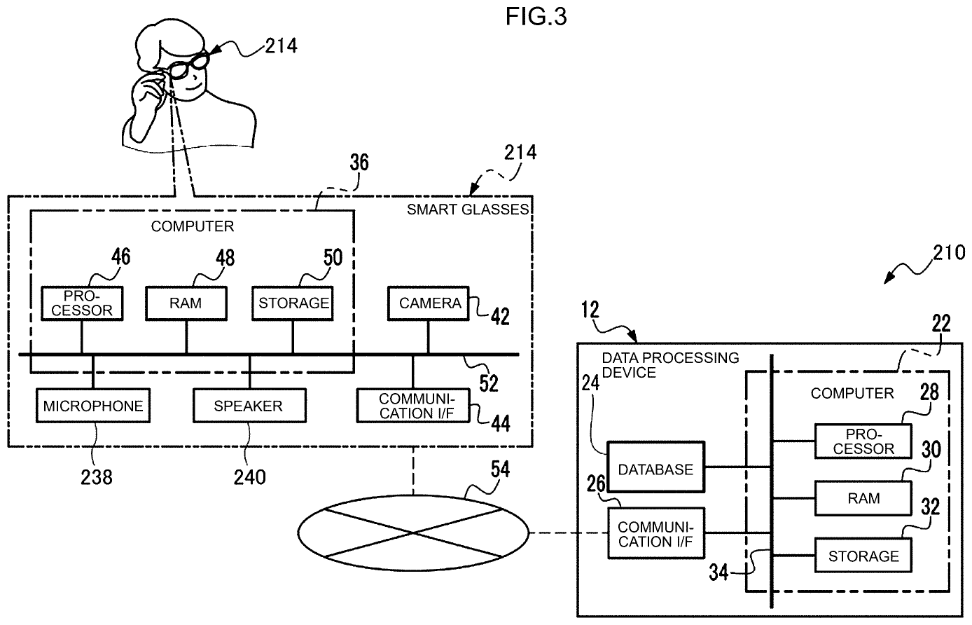

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

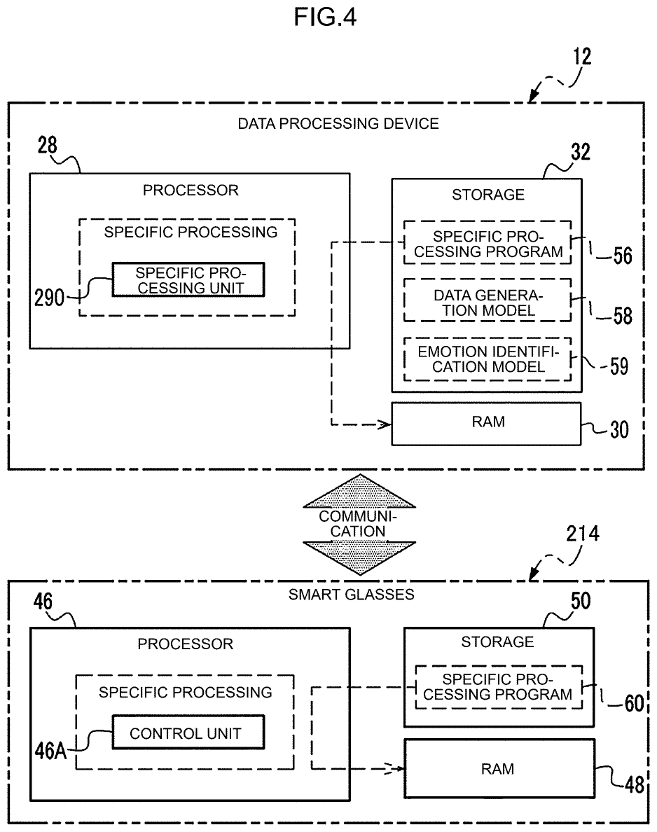

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned reception unit, generation unit, input unit, and creation unit is implemented by at least one of, for example, smart glasses 214 and a data processing apparatus 12. For example, the reception unit is implemented by a control unit 46A of the smart glasses 214 and inputs a kitting item name. The generation unit is implemented, for example, by a specific processing unit 290 of the data processing apparatus 12 and generates a response using a generative AI. The input unit is implemented, for example, by the control unit 46A of the smart glasses 214 and inputs the generated response into a master template. The creation unit is implemented, for example, by the specific processing unit 290 of the data processing apparatus 12 and automatically creates a kitting procedure manual based on the input master. The correspondence between each unit and the apparatus or control unit is not limited to the examples described above and various modifications are possible.

### Third Embodiment

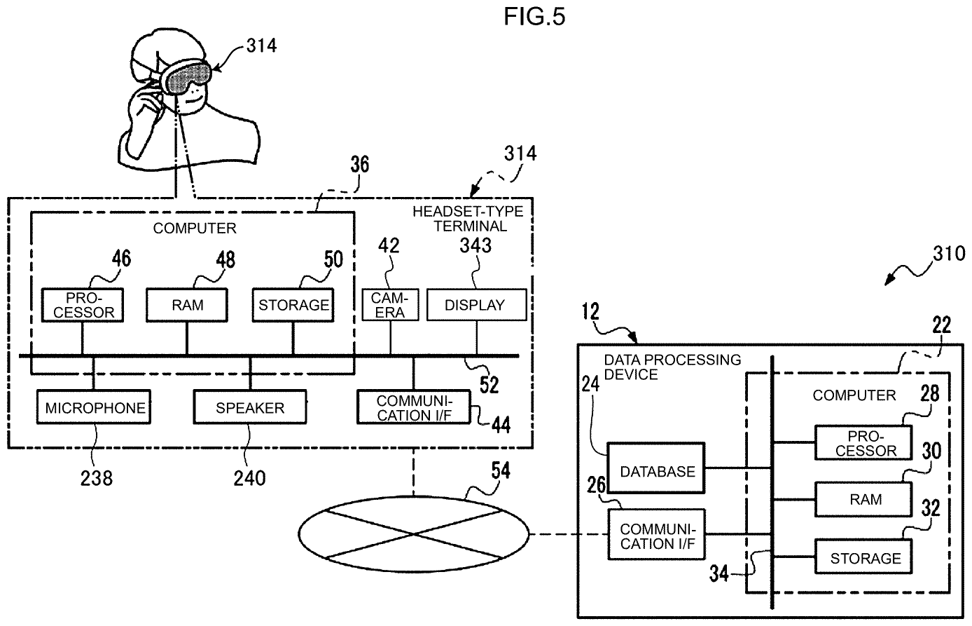

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

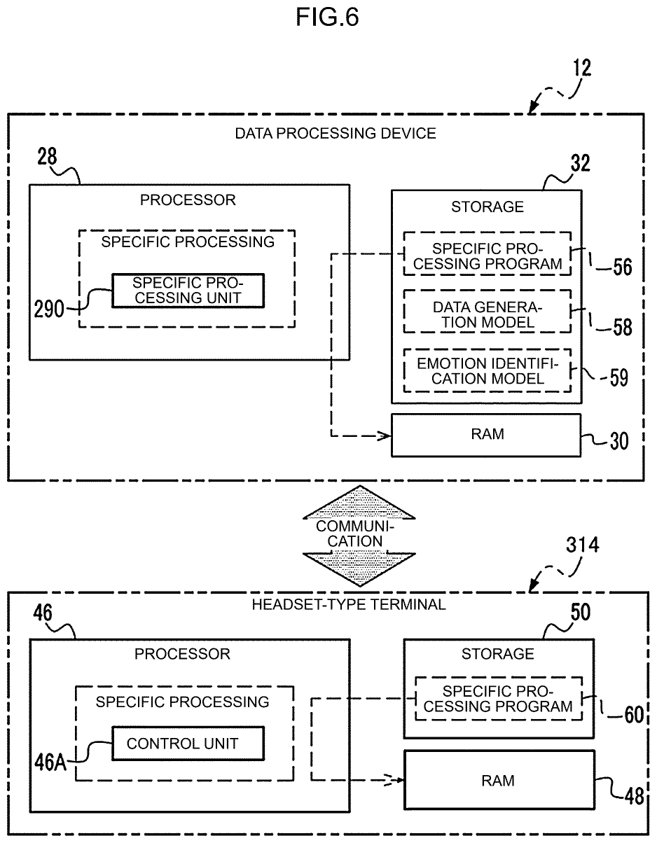

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned reception unit, generation unit, input unit, and creation unit is implemented by at least one of, for example, a headset-type terminal 314 and a data processing apparatus 12. For example, the reception unit is implemented by a control unit 46A of the headset-type terminal 314 and inputs a kitting item name. The generation unit is implemented, for example, by a specific processing unit 290 of the data processing apparatus 12 and generates a response using a generative AI. The input unit is implemented, for example, by the control unit 46A of the headset-type terminal 314 and inputs the generated response into a master template. The creation unit is implemented, for example, by the specific processing unit 290 of the data processing apparatus 12 and automatically creates a kitting procedure manual based on the input master. The correspondence between each unit and the apparatus or control unit is not limited to the examples described above and various modifications are possible.

### Fourth Embodiment

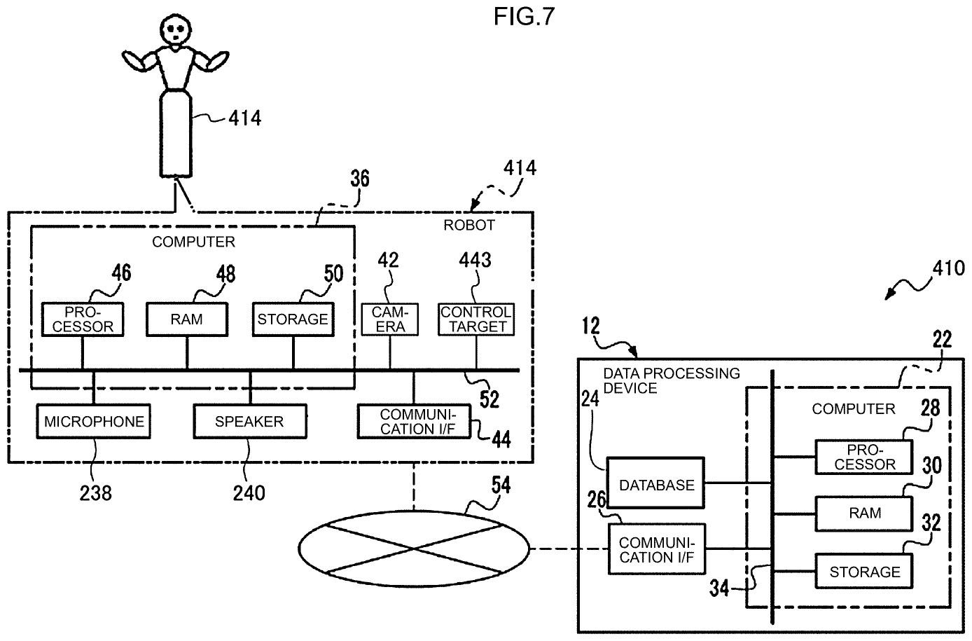

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

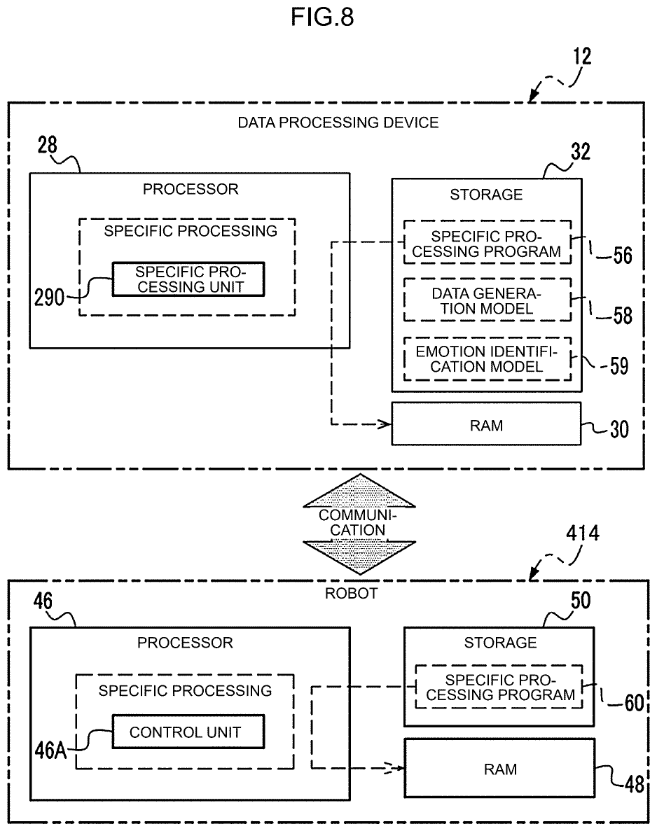

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned reception unit, generation unit, input unit, and creation unit is implemented by at least one of, for example, a robot 414 and a data processing apparatus 12. For example, the reception unit is implemented by a control unit 46A of the robot 414 and inputs a kitting item name. The generation unit is implemented, for example, by a specific processing unit 290 of the data processing apparatus 12 and generates a response using a generative AI. The input unit is implemented, for example, by the control unit 46A of the robot 414 and inputs the generated response into a master template. The creation unit is implemented, for example, by the specific processing unit 290 of the data processing apparatus 12 and automatically creates a kitting procedure manual based on the input master. The correspondence between each unit and the apparatus or control unit is not limited to the examples described above and various modifications are possible.

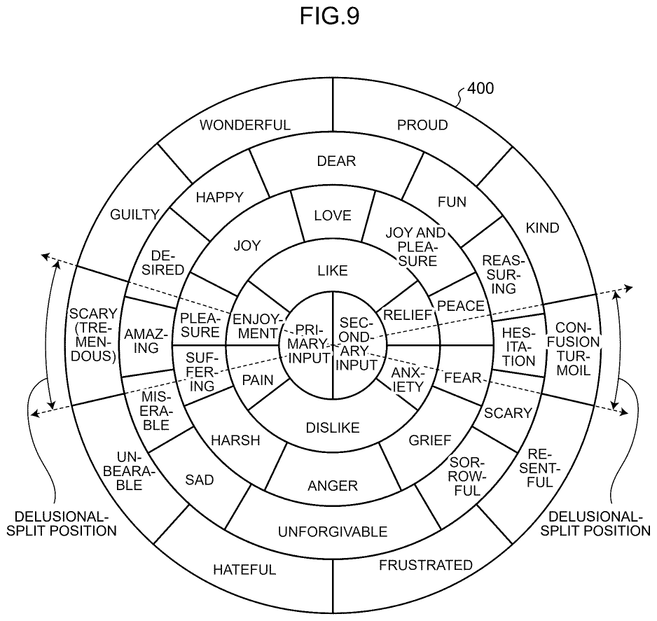

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

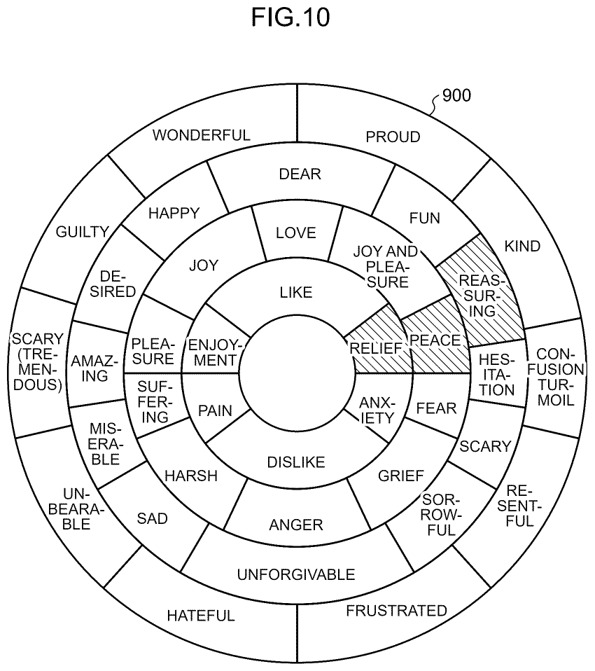

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: a reception unit configured to receive input of a kitting item name; a generation unit configured to generate a response based on the item name input by the reception unit; an input unit configured to input the response generated by the generation unit into a master template; and a creation unit configured to automatically create a kitting procedure manual based on the master input by the input unit.
(Supplementary Note 2)The system according to Supplementary Note 1, wherein the generation unit is configured to generate specific setting procedures based on the item name using a generative AI.
(Supplementary Note 3)The system according to Supplementary Note 1, wherein the input unit is configured to input the generated response into the master template.
(Supplementary Note 4)The system according to Supplementary Note 1, wherein the creation unit is configured to automatically create a procedure manual based on the created master by inputting the kitting item name.
(Supplementary Note 5)The system according to Supplementary Note 1, wherein the generation unit is configured to generate a response based on an algorithm or training data of the generative AI.
(Supplementary Note 6)The system according to Supplementary Note 1, wherein the creation unit is configured to provide the generated procedure manual to a user.
(Supplementary Note 7)The system according to Supplementary Note 1, wherein the reception unit is configured to estimate a user's emotion and adjust the timing of inputting the kitting item name based on the estimated emotion of the user.
(Supplementary Note 8)The system according to Supplementary Note 1, wherein the reception unit is configured to analyze a user's past input history and select an appropriate input method.
(Supplementary Note 9)The system according to Supplementary Note 1, wherein the reception unit is configured to perform filtering based on the user's current project or area of interest when inputting the kitting item name.
(Supplementary Note 10)The system according to Supplementary Note 1, wherein the reception unit is configured to estimate a user's emotion and determine the priority of kitting item names to be input based on the estimated emotion of the user.
(Supplementary Note 11)The system according to Supplementary Note 1, wherein the reception unit is configured to preferentially input relevant kitting item names by considering the user's geographic location information when inputting the kitting item name.
(Supplementary Note 12)The system according to Supplementary Note 1, wherein the reception unit is configured to analyze the user's social media activity and input related kitting item names when inputting the kitting item name.
(Supplementary Note 13)The system according to Supplementary Note 1, wherein the generation unit is configured to estimate a user's emotion and adjust the expression method of the generated procedure based on the estimated emotion of the user.
(Supplementary Note 14)The system according to Supplementary Note 1, wherein the generation unit is configured to adjust the level of detail of the generated procedure based on the importance of the item name during generation.
(Supplementary Note 15)The system according to Supplementary Note 1, wherein the generation unit is configured to apply different generation algorithms according to the category of the item name during generation.
(Supplementary Note 16)The system according to Supplementary Note 1, wherein the generation unit is configured to estimate a user's emotion and adjust the length of the generated procedure based on the estimated emotion of the user.
(Supplementary Note 17)The system according to Supplementary Note 1, wherein the generation unit is configured to determine the priority of the generated procedure based on the submission timing of the item name during generation.
(Supplementary Note 18)The system according to Supplementary Note 1, wherein the generation unit is configured to adjust the order of the generated procedure based on the relevance of the item name during generation.
(Supplementary Note 19)The system according to Supplementary Note 1, wherein the input unit is configured to estimate a user's emotion and adjust the input method to the template based on the estimated emotion of the user.
(Supplementary Note 20)The system according to Supplementary Note 1, wherein the input unit is configured to adjust the level of detail of the input based on the importance of the generated procedure during input.
(Supplementary Note 21)The system according to Supplementary Note 1, wherein the input unit is configured to apply different input algorithms according to the category of the template during input.
(Supplementary Note 22)The system according to Supplementary Note 1, wherein the input unit is configured to estimate a user's emotion and adjust the order of input to the template based on the estimated emotion of the user.
(Supplementary Note 23)The system according to Supplementary Note 1, wherein the input unit is configured to determine the priority of input based on the submission timing of the generated procedure during input.
(Supplementary Note 24)The system according to Supplementary Note 1, wherein the input unit is configured to adjust the order of input based on the relevance of the generated procedure during input.
(Supplementary Note 25)The system according to Supplementary Note 1, wherein the creation unit is configured to estimate a user's emotion and adjust the method of creating the procedure manual based on the estimated emotion of the user.
(Supplementary Note 26)The system according to Supplementary Note 1, wherein the creation unit is configured to adjust the level of detail of the procedure manual based on the importance of the generated procedure during creation.
(Supplementary Note 27)The system according to Supplementary Note 1, wherein the creation unit is configured to apply different creation algorithms according to the category of the procedure manual during creation.
(Supplementary Note 28)The system according to Supplementary Note 1, wherein the creation unit is configured to estimate a user's emotion and adjust the display method of the procedure manual based on the estimated emotion of the user.
(Supplementary Note 29)The system according to Supplementary Note 1, wherein the creation unit is configured to determine the priority of the procedure manual based on the submission timing of the generated procedure during creation.
(Supplementary Note 30)The system according to Supplementary Note 1, wherein the creation unit is configured to adjust the order of the procedure manual based on the relevance of the generated procedure during creation.

What is claimed is:

1. A system comprising:
a communication interface configured to communicate with a client terminal via a packet-switched network;
a memory storing a data generation model comprising a Transformer-based architecture obtained by deep learning on a neural network; and
circuitry configured to:
receive, from the client terminal via the communication interface, item name data identifying a kitting item;
tokenize the item name data and input the tokenized item name data into the data generation model to generate procedure data comprising setting procedures for the kitting item;
map the procedure data to designated fields of a template data structure stored in the memory; and
generate, based on the template data structure with the mapped procedure data, a procedure manual file and transmit the procedure manual file to the client terminal via the communication interface and the packet-switched network.

2. The system according to claim 1, wherein the data generation model comprises a large language model having one billion to one hundred billion parameters.

3. The system according to claim 1, wherein the circuitry is further configured to assign a confidence score to the procedure data and perform threshold determination based on the confidence score to determine whether to include the procedure data in the procedure manual file.

4. The system according to claim 1, wherein the template data structure comprises at least one of an Excel template or a relational database table, and wherein the circuitry is configured to map the procedure data to fields comprising at least one of a title field, a description field, or a caution field.

5. The system according to claim 1, wherein the procedure manual file is generated in at least one of a PDF format, an HTML format, or a Markdown format.

6. The system according to claim 1, wherein the memory further stores an emotion identification model, and wherein the circuitry is further configured to estimate an emotion of a user by applying the emotion identification model to sensor data received from the client terminal, and to adjust a timing of receiving the item name data based on the estimated emotion.

7. The system according to claim 6, wherein the circuitry is further configured to adjust an expression style of the procedure data based on the estimated emotion, such that when the estimated emotion indicates relaxation, the procedure data is generated in a detailed expression style, and when the estimated emotion indicates urgency, the procedure data is generated in a concise expression style.

8. The system according to claim 6, wherein the circuitry is further configured to adjust a length of the procedure data based on the estimated emotion, such that when the estimated emotion indicates urgency, the circuitry generates short procedure data focusing on key points, and when the estimated emotion indicates relaxation, the circuitry generates longer procedure data with detailed explanations.

9. The system according to claim 1, wherein the circuitry is further configured to analyze a past input history of a user stored in the memory to predict a next item name and optimize an input interface based on the prediction.

10. The system according to claim 1, wherein the circuitry is further configured to perform filtering based on a current project attribute of a user when receiving the item name data, and to preferentially display item names related to the current project.

11. The system according to claim 1, wherein the circuitry is further configured to receive geographic location information from the client terminal and to preferentially receive item name data associated with a geographic region corresponding to the geographic location information.

12. The system according to claim 1, wherein the circuitry is further configured to analyze social media activity data of a user received from the client terminal and to suggest item names based on the analyzed social media activity data.

13. The system according to claim 1, wherein the circuitry is further configured to adjust a level of detail of the procedure data based on an importance score associated with the item name data, such that for item name data having a high importance score, the circuitry generates detailed procedure data, and for item name data having a low importance score, the circuitry generates concise procedure data.

14. The system according to claim 1, wherein the circuitry is further configured to apply different generation algorithms according to a category of the item name data, such that for network-related item names, the circuitry applies a network configuration generation algorithm, and for software-related item names, the circuitry applies a software installation generation algorithm.

15. The system according to claim 1, wherein the circuitry is further configured to determine a priority of generating the procedure data based on a submission deadline associated with the item name data, such that item name data having an imminent submission deadline is processed with a higher priority.

16. The system according to claim 1, wherein the circuitry is further configured to adjust an order of procedures in the procedure manual file based on a relevance score between item names, such that procedures with high relevance are placed in adjacent sections.

17. The system according to claim 1, wherein the circuitry is further configured to perform layout optimization on the procedure manual file comprising at least one of adjusting page break positions, automatic insertion of figures and tables, or automatic generation of a table of contents.

18. A system comprising:
a communication interface configured to communicate, via a packet-switched network conforming to at least one of a 5G, Wi-Fi, or Bluetooth communication standard, with a client terminal comprising a touch panel, a microphone, a speaker, a camera having a CMOS image sensor, and a display;
a processor;
a random-access memory;
a memory storing a data generation model comprising a Transformer-based large language model obtained by deep learning on a neural network, and an emotion identification model;
a database; and
circuitry configured to:
receive, from the client terminal via the communication interface, item name data identifying a kitting item, the item name data comprising at least one of text data input via the touch panel or voice data captured by the microphone;
tokenize the item name data using subword segmentation to generate a token sequence, and input the token sequence into the data generation model to generate procedure data comprising setting procedures for the kitting item;
estimate an emotion of a user by applying the emotion identification model to at least one of voice data captured by the microphone or image data captured by the camera;
adjust at least one of a length, a level of detail, or an expression style of the procedure data based on the estimated emotion;
map the procedure data to designated fields of a template data structure and store the mapped data in the database; and
generate, based on the template data structure with the mapped procedure data, a procedure manual file in at least one of a PDF format, an HTML format, or a Markdown format, and transmit the procedure manual file to the client terminal via the communication interface, the procedure manual file causing the client terminal to present the procedure manual file to the user via at least one of the display or the speaker.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a system comprising a communication interface, a memory storing a data generation model comprising a Transformer-based architecture obtained by deep learning on a neural network, the method comprising:
receiving, from a client terminal via the communication interface and a packet-switched network, item name data identifying a kitting item;
tokenizing the item name data and inputting the tokenized item name data into the data generation model to generate procedure data comprising setting procedures for the kitting item;
mapping the procedure data to designated fields of a template data structure stored in the memory; and
generating, based on the template data structure with the mapped procedure data, a procedure manual file and transmitting the procedure manual file to the client terminal via the communication interface and the packet-switched network.
